(19) United States
(12) Patent Application Publication
(10) Pub. No.: US 2022/0188818 A1
(43) Pub. Date: Jun. 16, 2022

(54) COMPUTING PLATFORM FOR LITIGATION FUNDING AND INITIAL LITIGATION OFFERINGS

(71) Applicant: Ava Labs, Inc., Brooklyn, NY (US)

(72) Inventors: Kyle Roche, Brooklyn, NY (US); Kevin Sekniqi, Brooklyn, NY (US)

(21) Appl. No.: 17/549,836

(22) Filed: Dec. 13, 2021

Related U.S. Application Data
(60) Provisional application No. 63/124,583, filed on Dec. 11, 2020.

(51) Int. Cl. G06Q 20/38; G06Q 50/18; H04L 9/32

(52) U.S. Cl. CPC G06Q 20/38215; G06Q 2220/123; H04L 9/3213; G06Q 50/18

(57) ABSTRACT

A system and method for providing a litigation funding platform and exchange can include a user device that generates a litigation event, an initial litigation product offering (ILO) computer system, and a digital exchange system. The ILO system can receive the litigation event, generate (i) a litigation product contract, (ii) a master product key pair for the litigation event that includes a public and private key, and (iii) a freeze rule. The ILO system can also provide an initial offering of such tokens, receive requests to purchase the tokens, generate a plurality of the tokens, and generate a token ledger. The digital exchange system can match digital trades of the litigation product tokens using the token ledger. The digital exchange system can permit or block the trade based at least in part on whether a freeze event has been validated and invoked for the particular litigation product token.

### CROSS-REFERENCE TO RELATED PATENT APPLICATIONS

This application claims the benefit of U.S. Provisional Application No. 63/124,583, filed Dec. 11, 2020, the contents of which are incorporated by reference herein

### TECHNICAL FIELD

The present document generally relates to computing platforms for generating, exchanging, and reconciling digital tokens to facilitate funding litigation.

### BACKGROUND

Litigation can be costly, both in terms of monetary expenses incurred in pursuing meritorious claims (e.g., attorney and expert witness fees, discovery costs, attorney fees) and extensive time commitments to reach a resolution. Because of these costs, parties can oftentimes lack significant resources when stacked up against adversaries that are well-funded.

Litigation funding, also known as legal financing and third-party litigation funding, can provide parties, who otherwise lack the necessary resources, with funds needed to litigate or arbitrate claims. Some litigation financing firms can be privately held and target institutional investors based on minimal investment levels. Litigation financing firms can receive financial returns that are uncorrelated to broader market conditions. In other words, overall performance of the equities market does not impact performance of the litigation financing firms.

In some litigation funding arrangements, a funder (e.g., litigation financing firm) can agree to provide a litigant money in exchange for (1) an interest or a multiplier on the investment or (2) a percentage of the overall recovery in litigation. In these arrangements, the funder bears the risk in the event the litigation is unsuccessful. Where the litigation is successful, the funder shares in the financial recovery. Retail investors may not be able to partake in litigation funding arrangements. Investing in litigation can require substantial capital investments and tie up funds for periods of time that depend on when litigation reaches a resolution.

### SUMMARY

The disclosed technology is generally directed to providing a computing environment and platform to generate, exchange, and reconcile digital tokens to facilitate market-based investing in litigation funding opportunities. Such a computing environment and platform can provide, for example, a blockchain-based initial litigation offering (“ILO”) and digital exchange to provide a market for trading litigation funding tokens. For instance, the computing environment can provide a platform for parties having litigation claims to receive funding from a variety of different investors, including both accredited and non-accredited inventors. A pool of investment products or tokens (e.g., litigation product tokens) can be generated and initially offered for each litigation matter (e.g., lawsuit), which can generate funding for the litigation matter. In other words, the computing environment can tokenize funding for different litigations. The tokens can be exchanged in the marketplace for a duration of the litigation claim. Token holders can hold the tokens and monitor developments of the litigation through public filings. The token holders can then choose to keep or exchange their tokens in the marketplace.

Some tokens can be immediately exchanged or tradable in the marketplace if the token is initially offered to an accredited investor. Where the token is initially offered to a non-accredited investor, the token can be locked for a period of time (e.g., one year), during which the token may be restricted from be traded. After the lockup period ends (e.g., after a one-year period elapses), a token initially offered to a non-accredited investor can be traded like other tokens. Up until the ILO tokens are removed from circulation, which can occur upon resolution of the litigation (e.g., settlement, dismissal, verdict, finality of appeal), entities can trade and/or exchange the tokens in a manner that is compliant with U.S. securities laws. As the relevant legal proceedings carry on and additional information comes to light, the value of the associated ILO tokens may fluctuate based on, for example, developments in the legal proceeding that may indicate a greater or lesser likelihood of a recovery. This secondary market structure can create liquidity in a market that, up until now, has traditionally been illiquid.

ILO tokens can be generated with and include a contract that outlines and binds the party and its representatives (e.g., law firm) being staked in the litigation to various terms, including outlining the terms around litigation recoveries and the proportion of those recoveries that would be distributed to each token holder. For example, a law firm representing the party seeking litigation funding can be bound by an

ILO token contract to hold funds in escrow until there is a settlement event in the litigation. Once the settlement event occurs, all associated tokens can be frozen in the marketplace and paid out. In other words, the computing environment can distribute the contemplated return to each ILO token holder pursuant to the terms of the ILO token contract. The ILO token contract can outline a variety of terms, such as terms for (1) communicating to all token holders the outcome of the litigation, (2) distributing funds to token holders through a U.S. dollar backed stablecoin, and (3) removing the associated ILO tokens from circulation. In the event that the settlement event does not include a successful recovery, the associated ILO token loses its value.

In some implementations, each ILO token holder can invest in an ILO token contract that will pay out a “multiplier” of the ILO token holder's investment in the event of a successful monetary recovery. That “multiplier” can increase over time, providing greater financial returns for the ILO token holder the longer the investment is committed. In other implementations, each ILO token holder can invest in an ILO token contract that can pay out a “percentage” of the overall recovery in the litigation.

In some implementations, a system for providing a litigation funding platform and exchange can include a user device configured to generate a litigation event, an initial litigation product offering (ILO) computer system, and a digital exchange system. The ILO computer system can receive, from the user device, the litigation event, generate, based on the litigation event, (i) a litigation product contract, (ii) a master product key pair for the litigation event that includes a public key and a private key, and (iii)a freeze rule, provide an initial offering of litigation product tokens, wherein the initial offering incorporates, at least, the litigation product contract, receive requests to purchase the litigation product tokens as part of the initial public offering, generate a plurality of litigation product tokens that each include the litigation product contract, the public key, and the freeze rule, and generate a token ledger that includes initial entries for the plurality of litigation product tokens. The digital exchange system can match digital trades of the plurality of litigation product tokens using the token ledger. Matching a digital trade for a particular litigation product token can include (i) determining whether to permit the digital trade based, at least in part, on whether a freeze event is present in the token ledger for the particular litigation product token and whether a signature included as part of the freeze event is validated by the public key, and (ii) blocking the digital trade when the freeze event is present in the token ledger and the signature is validated by the public key.

In some implementations, one or more of the following features can be included. The initial litigation product offering computer system can also determine whether entities associated with each of the requests is an accredited entity or non-accredited entity based on signatures associated with the entities. Each of the plurality of litigation product tokens can be generated as either being locked or unlocked based on whether a corresponding entity purchasing the litigation product token is an accredited entity or a non-accredited entity. The digital exchange system can also permit matching of trades for unlocked tokens using the token ledger and block matching of trades for locked tokens that are within a lockup period for the litigation product tokens. The lockup period can include a predefined period of time that starts to run at a time when the litigation product tokens were initially generated. The lockup period can be one year long from the timestamp for the locked instance of the litigation product token.

The initial litigation product offering computer system can also receive, from the user device, (i) a settlement event and (ii) a request to invoke a freeze event, generate, based on the private key from the user device, a signature for the settlement event, and send, to the digital exchange system for all of the plurality of litigation product tokens, (i) the request to invoke the freeze event, and (ii) the signature for the settlement event. For each of the plurality of litigation product tokens, the digital exchange system can also receive, from the initial litigation product offering computer system, (i) the request to invoke the freeze event, and (ii) the signature for the settlement event, retrieve, from the token ledger, the public key, validate, using the freeze rule, the signature for the settlement event using the public key, and add the freeze event to the token ledger for the litigation product token. The initial litigation product offering computer system can also verify that all the instances of the litigation product token are frozen in the digital exchange, retrieve, from the token ledger, addresses for entities that are assigned the addresses for all the instances of the litigation product token, determine, based on the received addresses for the entities, last prior addresses for the entities that were assigned to the addresses for all the instances of the litigation product token before execution of the freeze event, and pay out each of the instances of the litigation product token to the last prior addresses for the entities. The initial litigation product offering computer system can also determine, for each of the last prior addresses for the entities, whether the last prior address is associated with an authenticated entity, and in response to determining that a particular last prior address is not associated with an authenticated entity, can send to the particular last prior address, a notification that an authentication process is to be performed by the entity before instances of the litigation product token are to be paid out to the particular last prior address for the entity. The initial litigation product offering computer system can also pay out each of the instances of the litigation product token in a stable currency. The initial litigation product offering computer system can also dissolve the litigation product token after paying out each of the instances of the litigation product token. Dissolving the litigation product token can include removing the litigation product token from circulation in the digital exchange and removing a value assigned to the litigation product token.

In some implementations, the litigation event can be a start of a lawsuit or legal claim. The litigation product contract can be a smart contract. The freeze rule can be executed by the digital exchange system based on determining that a valid settlement event has occurred. The litigation product contract can include a payout rule that designates a stable currency to pay out litigation product token returns.

In some implementations, the private key can be stored at the user device. The settlement event can be a phase in the litigation event when resolution is being negotiated by parties to the litigation event. In other implementations, locked instance of the litigation product token can be prevented from being traded in the digital exchange for a period of time that begins when the locked instance of the litigation product token is generated. In some implementations, the digital exchange system can also send, to an address of the entity, a notification that the sell request was denied. The notification can indicate that the instance of the litigation product token is the locked instance of the litigation product token. The digital exchange system can also send, to the address of the second entity, a copy of the litigation product contract associated with the instance of the litigation product token. The copy of the litigation product contract can include at least the payout rule. The digital exchange system can also send, to addresses for entities that are assigned the addresses for all the instances of the litigation product token, a notification indicating at least one of (i) occurrence of the settlement event and (ii) execution of the freeze event. In some implementations, execution of the freeze event can include preventing all the instances of the litigation product token from being traded in the digital exchange from a time at which (i) the settlement event occurs or (ii) the freeze event is executed. Execution of the freeze event can also include stopping sell requests for one or more instances of the litigation product token. The sell requests can occur at a time at which (i) the settlement event occurs or (ii) the freeze event is executed. Implementations can include any, all, or none of the above mentioned features.

In some implementations, a method for providing a litigation funding platform and exchange can include receiving a litigation event, generating, based on the litigation event, (i) a litigation product contract, (ii) a master product key for the litigation event that includes a public key and a private key, and (iii) a freeze rule, providing an initial offering of litigation product tokens, wherein the initial offering incorporates, at least, the litigation product contract, receiving requests to purchase the litigation product tokens as part of the initial public offering, generating a plurality of litigation product tokens that each include the litigation product contract, the public key, and the freeze rule, generating a token ledger that includes initial entries for the plurality of litigation product tokens, and matching digital trades of the plurality of litigation product tokens using the token ledger. Matching a digital trade for a particular litigation product token can include (i) determining whether to permit the digital trade based, at least in part, on whether a freeze event is present in the token ledger for the particular litigation product token and whether a signature included as part of the freeze event is validated by the public key, and (iii) blocking the digital trade when the freeze event is present in the token ledger and the signature is validated by the public key.

In some implementations, one or more of the following features can be included. For example, the method can include determining whether entities associated with each of the requests is an accredited entity or non-accredited entity based on signatures associated with the entities. Each of the plurality of litigation product tokens can be generated as either being locked or unlocked based on whether a corresponding entity purchasing the litigation product token is an accredited entity or a non-accredited entity. The method can also include permitting matching of trades for unlocked tokens using the token ledger, and blocking matching of trades for locked tokens that are within a lockup period for the litigation product tokens. The lockup period can include a predefined period of time that starts to run at a time when the litigation product tokens were initially generated. As another example, the method can further include generating a notification that the matching of trades was blocked. The notification can indicate that the trade was for locked tokens that are within the lockup period for the litigation product tokens. Implementations can include any, all, or none of the above mentioned features.

In some implementations, a method for freezing a litigation product token in a litigation funding platform and exchange and include receiving (i) a settlement event, (ii) a request to invoke a freeze event, generating a signature for the settlement event, retrieving, from a ledger, a public master product key that is associated with the litigation product token, validating, using a freeze rule, the signature for the settlement event using the public master product key, and adding the freeze event to a token ledger for the litigation product token.

One or more of the following features can also be included. For example, the method can also include verifying that all the instances of the litigation product token are frozen in the litigation funding platform and exchange, retrieving, from the token ledger, addresses for entities that are assigned the addresses for all the instances of the litigation product token, determining, based on the received addresses for the entities, last prior addresses for the entities that were assigned to the addresses for all the instances of the litigation product token before adding the freeze event to the token ledger, and paying out each of the instances of the litigation product token to the last prior addresses for the entities. The method can also include dissolving the litigation product token. Dissolving the litigation product token can include removing the litigation product token from circulation in the litigation funding platform and exchange, and removing a value assigned to the litigation product token. In some implementations, executing the freeze event can include determining that a valid settlement event has occurred. The litigation funding platform and exchange can also be operated by a digital exchange system. In some implementations, the method can also include generating a notification indicating at least one of (i) an occurrence of the settlement event and (ii) adding the freeze event to the token ledger. Adding the freeze event to the token ledger can include preventing all the instances of the litigation product token from being traded in the litigation funding platform and exchange from a time at which (i) the settlement event occurs or (ii) the freeze event is added to the token ledger. Adding the freeze event to the token ledger can include stopping sell requests for one or more instances of the litigation product token. The sell requests can occur at a time at which (i) the settlement event occurs or (ii) the freeze event is executed. Implementations can include any, all, or none of the above mentioned features.

Various advantages can be provided by embodiments of the disclosed technology. For example, the disclosed technology can provide an environment or marketplace for different investors to invest in litigations. In other words, more entities have an opportunity to contribute to litigation funding. Some conventional litigation investment arrangements may exist between a party to a litigation and a privately held litigation financing firm. As a result, many potential investors or entities may not receive an opportunity to invest in the litigation. On the other hand, with the disclosed technology, retail investors, individuals, and any other types of entities can be presented with opportunities to invest in different litigations by buying and/or trading tokens associated with those litigations.

As another example, the disclosed technology can promote litigation funding so that a party to the litigation can achieve the necessary financial means to pursue the litigation. As mentioned, many different investors can buy, sell, and otherwise trade or exchange tokens for a lifetime of the litigations. Based on events in the litigations, token values can fluctuate, which can incentivize more entities to invest in the litigation. So long as the litigation is not yet settled, entities can keep investing in the litigation and the associated token value can increase. Therefore, the party seeking the funding can obtain the necessary funds to litigate their claim(s).

As another example, the disclosed technology can liquefy the market for litigation funding. Traditional litigation funding techniques can be illiquid, which can disincentivize potential investors from investing in litigation funding. Because fewer entities engage in litigation funding, returns on investments can be lower for the investing entities. Even more so, when entities are disincentivized from investing in litigation funding, parties seeking funding may not be able to acquire the necessary financial support to pursue their litigations. The disclosed technology, on the other hand, creates liquidity in the market, which results in higher investment returns and fluctuating token values.

As yet another example, the disclosed technology can provide for token trading that is aligned with U.S. securities laws and trading practices. Tokens that require registration or an exemption can be initially offered to non-accredited investors and then locked for a one-year period during which time those tokens cannot be traded.

Simultaneously, tokens that are initially offered to accredited investors can be freely traded in the market for a duration of the associated litigations. Such a locking feature can be advantageous to ensure lawful financial trading practices.

As another example, the disclosed technology can provide tokens that are capable of being frozen—meaning restricted from being further traded on exchanges—upon the litigation reaching a conclusion (e.g., settlement, dismissal, verdict). Freezing tokens effectively locks down the pool of token owners so that recoveries can be distributed. For example, a single public and private key pair can be generated for a litigation, with the public key being included in each of the tokens for the litigation (same public key in each token) and the private key can be retained by the litigation party.

Upon termination of the litigation, the litigation party can add a freezing event to the ledger for each token in the litigation pool with a signature value generated from the private key. The nodes administering the exchange are then able to verify the freezing event using the public key included in each of the tokens and, upon verification, can prohibit further exchanges of the tokens. Freezing the tokens at a token level (vs. freezing an address) ensures that particular tokens associated with a particular litigation can be restricted from being transferred, while not limiting the transfer of other tokens held by an individual. The freeze event can prevent, for example, investors from rapidly buying or selling the token based on the settlement event or outcome of the settlement event. Moreover, by freezing the token, token holders immediately prior to the freeze event can be fixed so that the recovery can be paid out to all token holders. Conventional blockchains and exchanges have not include global key pairs to be used to freeze the exchange of digital tokens, in part, because it would pose a security risk to the exchange. However, the disclosed technology presents unique problems that this feature solves. For example, due to the unique nature of the exchange really having a limited lifespan from the initial offering to the terminating event (e.g., settlement) and needing a way to fix the owner pool so that recoveries can be distributed, the use of the global key pair across all tokens and the configuring the nodes to validate freeze events provides a solution. Other features, aspects and potential advantages can be apparent from the accompanying description and figures.

### DESCRIPTION OF DRAWINGS

FIG. 1 is a conceptual diagram of an example computing environment for litigation funding as described herein.

FIG. 2 is a schematic diagram of operations in the example computing environment.

FIG. 3A depicts example token creation in a ledger.

FIG. 3B depicts an example token ledger when tokens are traded in a marketplace of the computing environment.

FIG. 3C depicts an example token ledger at a settlement event in the computing environment.

FIGS. 4A-D are a flowchart of a process for operating the computing environment.

FIGS. 5A-B are a swimlane diagram of a process for exchanging tokens in the computing environment.

FIGS. 6A-B are a swimlane diagram of a process for paying out tokens at a settlement event in the computing environment.

FIG. 7 is a system diagram of components of the example computing environment.

Like reference symbols in the various drawings indicate like elements.

### DETAILED DESCRIPTION

The disclosed technology is generally directed to providing a computing environment and platform to generate, exchange, and reconcile digital tokens to facilitate market-based investing in litigation funding opportunities. The computing environment can be a blockchain-based initial litigation offering (“ILO”) digital exchange, in which entities can trade/exchange tokens that are associated with different litigations. A pool of litigation product tokens can be assigned to each litigation matter. Token values can fluctuate during a course of the litigation based on development in the legal proceedings. Once a settlement event occurs in the litigation, tokens assigned to that litigation can be frozen in the digital exchange (e.g., marketplace) such that they can no longer be traded or exchanged. Once frozen, the computing environment can pay out the tokens to associated token holders (e.g., litigation investors). So long as the tokens are not frozen, unlocked tokens can be freely exchanged in the marketplace according to U.S. securities laws and trading practices. Tokens can be locked at an initial offering of such tokens when the initial token holder is a non-accredited investor. Such tokens can remain locked for a duration of time, in which the tokens cannot be traded or exchanged. In some examples, tokens can be locked in the marketplace for one year from a time of locking (e.g., the initial offering to the non-accredited investor). Once the lockup period ends, the initially locked tokens can be freely exchanged in the marketplace like any other tokens. Once the settlement event occurs in the litigation, a freeze event can be executed in the digital exchange, which prevents all tokens assigned to that litigation from being further traded on exchanges. Token returns can be paid out to each of the token holders and the token can be dissolved.

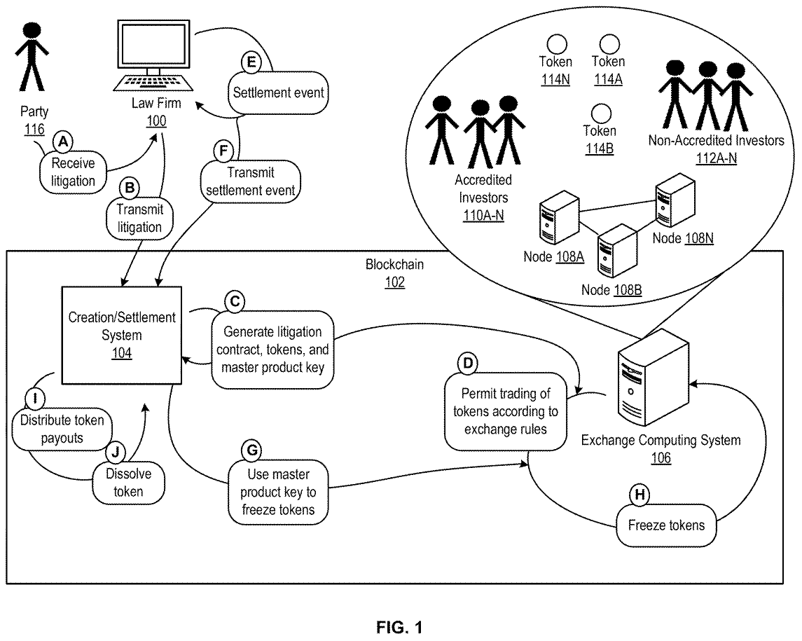

Referring to the figures, FIG. 1 is a conceptual diagram of an example computing environment for litigation funding as described herein. The example computing environment includes a creation/settlement system 104 (e.g., initial litigation offering, “ILO,” system) that is in communication with an exchange computing system 106 over a blockchain 102. The creation/settlement system 104 can exist on any blockchain. The creation/settlement system 104 can receive litigation from a law firm 100 or a party 116. The party 116 can be represented by the law firm 100. The party 116 and/or the law firm 100 can seek litigation funding (e.g., financial resources) to pursue the litigation. Therefore, the creation/settlement system 104 can generate and assign a token for the received litigation (e.g., a product, digital asset), permit trading of that token in the exchange computing system 106, freeze the token during a settlement event, and pay out token returns to token holders.

The exchange computing system 106 can be a digital exchange or marketplace configured to provide trading of digital assets. The exchange computing system 106 can be on the blockchain 102 or any other blockchain or distributed network. The exchange computing system 106 can already exist and/or facilitate transacting (e.g., buying, selling) of different types of tokens, currencies (e.g., cryptocurrencies), digital assets, and/or other financial or blockchain-based products. The system 106 can include one or more nodes 108A-N, accredited investors 110A-N, non-accredited investors 112A-N, and tokens 114A-N.

The nodes 108A-N can be configured to operate the exchange computing system 106 and maintain copies of data of the blockchain 102. The nodes 108A-N can verify and validate transactions occurring in the exchange computing system 106, verify whether investors are accredited or non-accredited, prevent trading of tokens that are initially locked, and freeze a pool of tokens during a settlement event.

Pursuant to securities laws and financial trading practices, accredited investors 110A-N (e.g., including foreign investors) can immediately trade the tokens 114A-N in the exchange computing system 106. Non-accredited investors 112A-N may not trade their tokens 114A-N during a one year period from initial generation of such tokens 114A-N. Thus, at token initiation, the token can be locked (e.g., for one year) or unlocked. If unlocked, the token can be freely traded in the exchange computing system 106 for a duration of the litigation or until a settlement event occurs in the litigation. If locked, the token cannot be traded in the exchange computing system 106 until the lockup period, beginning at token initiation, ends. Trading the token can increase value of the token, increase value of the litigation, and promote investing in the litigation, thereby helping to ensure that the party 116 and/or the law firm 100 can receive financial resources or funding to pursue the litigation.

Each of the tokens 114A-N can be assigned to a different litigation. For example, token 114A can be assigned to a first litigation. The first litigation can be from the law firm 100, the party 116, or any other law firm or party. Token 114B can be assigned to a second litigation. The second litigation can be from the law firm 100, the party 116, or any other law firm or party. Similarly, token 114N can be assigned to an nth litigation, which can be from the law firm 100, the party 116, or any other law firm or party. Once the litigation is settled or some resolution is reached (e.g., dismissal, verdict) and the associated token returns are paid out to token holders, the token can be dissolved.

In other words, the token no longer has value and no longer exists. New tokens can be generated for each new litigation that is received by the creation/settlement system 104.

Still referring to FIG. 1, the law firm 100 can receive litigation from the party 116 (A). The law firm 100 can transmit the litigation to the creation/settlement system 104 (B) (e.g., via wireless or wired communication). The creation/settlement system 104 can then generate a contract (e.g., smart contract), token, and master product key associated with that litigation (C). The master product key generation can include generating a single public and private key pair for the litigation. The same public key can be included in each generated token for the litigation (e.g., same public key in each token) and the private key can be retained by the law firm 100. The creation/settlement system 104 can be a third party vendor that facilitates key generation and issuance of tokens or other digital assets.

The contract and public master product key can be stored on the blockchain 102 (e.g., a distributed ledger). As mentioned, the contract and public master product key can be associated with each token that is generated for the litigation. The private master product key can be used to generate a signature for the law firm 100. The nodes 108A-N can use the signature to verify whether the law firm 100 is authorized to invoke a freeze event upon the happening of a settlement event in the litigation. Thus, the law firm 100 can retain the private master product key that corresponds to the public master product key. If the law firm 100 loses the private master product key, a new master product key can be generated and/or the associated token can be re-issued to any entity that held the token immediately prior to the law firm 100 losing the key.

The contract can dictate terms of trading the token and how the token will pay out upon a settlement outcome. For example, the contract can indicate expected payout of the token. The payout can be determined based on a number of factors. In some implementations, the token return (e.g., payout) can be based on a duration of the litigation. For example, if a settlement event does not occur until after one year of the litigation starts, the token return can be three times an entity's initial investment. The contract can also indicate whether the law firm 100 or the party 116 receives any overage from the settlement outcome once the token holders are paid out the token returns. For example, if an entity invests $1 and the token return is $3 but the actual settlement payout is $5, then the law firm 100 can receive the overage payout of $2. In other examples, the contract can indicate increases in payout where the actual settlement payout is greater than the expected payout. Therefore, in the previous example, the investing entity can receive the actual settlement payout of $5 rather than just the $3 token return. The contract can also indicate what happens when settlement is less than the expected payout. For example, a notification can be sent to all token holders indicating that the actual settlement payout is not as expected. The contract can indicate a reduced payout of the token return based on the actual settlement payout. The contract can also indicate what happens when settlement is adverse to the party 116. For example, if the party 116 loses the litigation, then the investing entities may not receive payout for the associated token. The token can therefore be dissolved by the creation/settlement system 104.

When tokens are generated (C) by the creation/settlement system 104, some tokens can be set to an initial lock status. Setting tokens to the initial lock status can depend on whether an entity making the initial offering is one of the accredited investors 110A-N or one of the non-accredited investors 112A-N. The accredited investors 110A-N and the non-accredited investors 112A-N can make initial offerings. In other words, the accredited investors 110A-N and/or the non-accredited investors 112A-N can request the tokens and offer a stable currency (e.g., U.S. dollar) in exchange for the tokens in a marketplace or digital exchange. For every stable coin offered, the accredited investors 110A-N can receive tokens that are immediately transferable in the exchange computing system 106 and the non-accredited investors 112A-N can receive tokens that are locked and not transferable for a one year period.

Tokens are set to the initial lock status when an initial offering of such tokens are to the non-accredited investors 112A-N. When tokens have the initial lock status, they cannot be traded in the exchange computing system 106 for one year from the initial offering. After the lockup period ends, these tokens can be freely traded in the exchange computing system 106. Tokens that are not set to the initial lock status (e.g., are unlocked) can be traded in the exchange computing system 106 by the accredited investors 110A-N from the time of initial offering.

Still referring to FIG. 1, trading of the generated litigation token can be permitted in the exchange computing system 106 (D). Trading can occur based on financial trading practices, U.S. securities laws, and/or existing exchange or marketplace rules. For a duration of the litigation, the accredited investors 110A-N can trade their tokens 114A-N on the exchange computing system 106. In other words, the tokens 114A-N that do not have the initial lock status can be immediately traded. The tokens 114A-N can be exchanged for other litigation tokens as well as other digital assets, crypto-currencies, blockchain-based products, and/or financial products that are transferable on the exchange computing system 106. The tokens 114A-N having the initial lock status can be prevented from being traded until the one year lockup period ends. For example, when an accredited investor 110A-N and/or a non-accredited investor 112A-N attempts to trade a locked token, the nodes 108A-N can verify against the associated litigation contract and public master product key whether the token has the initial lock status. If the token does have the initial lock status, then the nodes 108A-N can deny or prevent the trade from occurring. The investor that attempted trading that token can receive a notification in their wallet that the transaction failed.

At some point in time during the litigation, a settlement event occurs (E). The settlement event can be transmitted from the law firm 100 to the creation/settlement system 104 (F). Thus, the law firm 100 can add (i) a signature generated from the private master product key and (ii) a freeze event to the blockchain 102 (e.g., ledger) for each token assigned to the litigation that has the settlement event. The signature can be verified with the public master product key and the freeze event can be invoked (G). The creation/settlement system 104 can notify the nodes 108A-N that all trading of the associated token must be stopped. The nodes 108A-N of the exchange computing system 106 can then freeze the token associated with the litigation having the settlement event (H). The nodes 108A-N can be programmed to recognize the freeze event and verify the signature against the public master product key included in each of the tokens assigned to the litigation.

By freezing the token, all trading of that token is halted or stopped. The blockchain 102 can be modified such that the token can no longer be moved, modified, or used in any other transactions. This is advantageous to ensure that token holders do not trade their tokens based on the settlement event.

The creation/settlement system 104 can distribute token payouts (e.g., token returns) (I). Distribution can occur once the creation/settlement system 104 verifies that all the associated tokens were frozen by the nodes 108A-N. Therefore, the token returns can be paid out to entities that were token holders immediately prior to the freeze event's execution. As described herein, the token payouts can be determined based on terms in the litigation contract. The payouts can fluctuate based on a value or the token during the litigation and/or at the time of settlement or the freeze event. The payouts can also depend on whether the actual settlement payout is the same as the expected settlement payout at the time of generating the litigation contract. For example, where the settlement payout is greater than the expected payout, the token holders can receive greater token payouts. In the same example, the token holders can receive the expected payout and the law firm 100 can receive any overage of the settlement payout. As another example, where the settlement payout is less than the expected payout, the token holders can receive smaller token payouts.

The token returns can be paid out through a corresponding stable coin (e.g., currency). This can be accomplished using a same address that is associated with the token. This is different than conventional trading of digital assets because the token is not being swapped or converted into a stable currency. The token is instead being paid out through the stable currency.

Once the token returns are paid out to the associated token holders, the token can be dissolved (J). The token expires and carries no more value. The creation/settlement system 104 can generate other tokens for other litigations that arise.

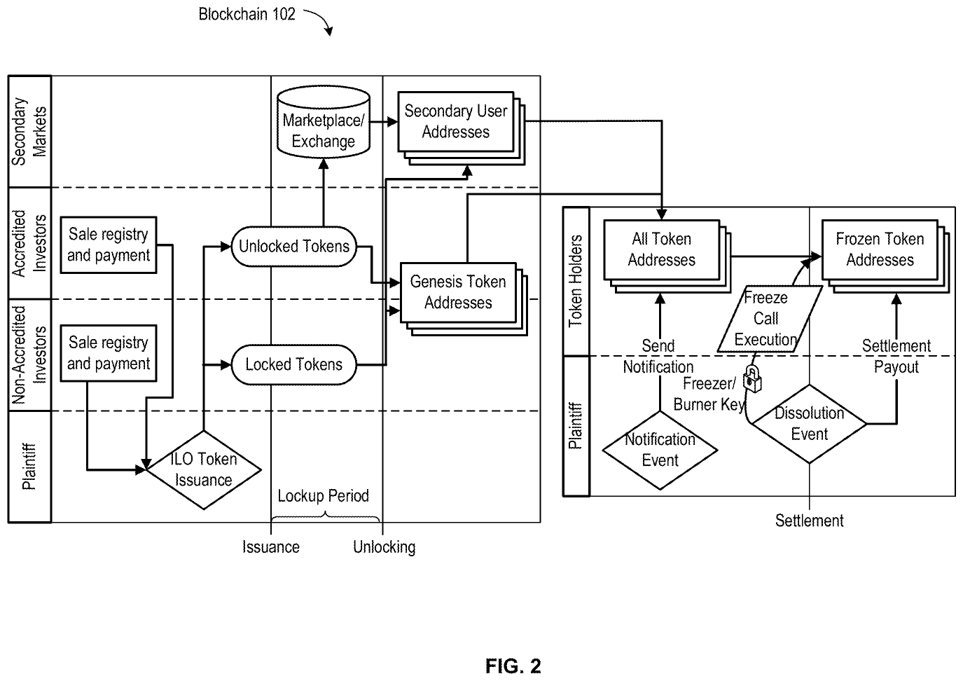

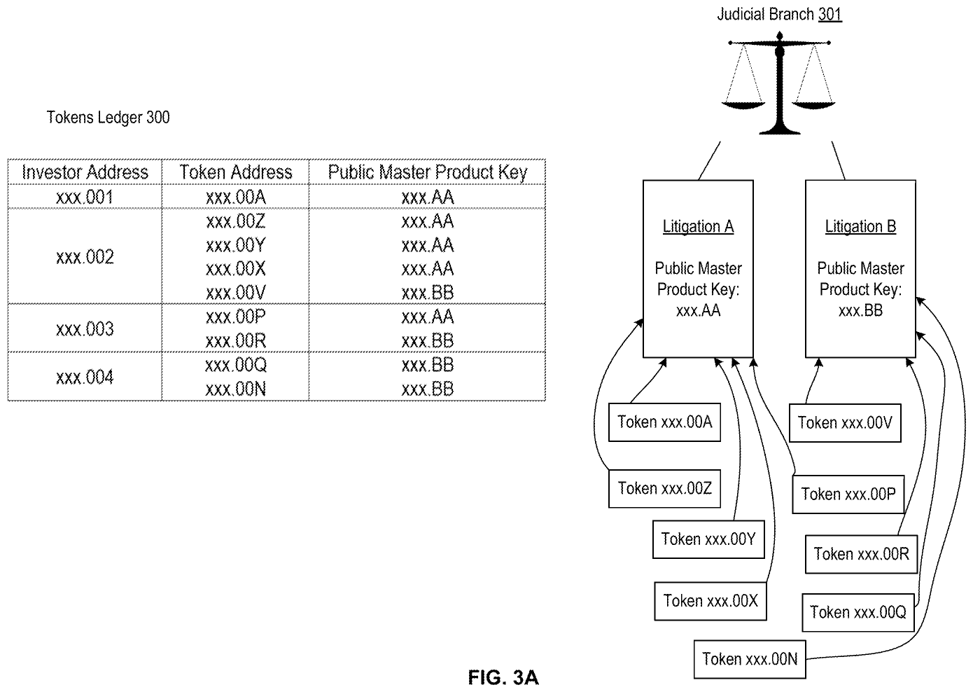

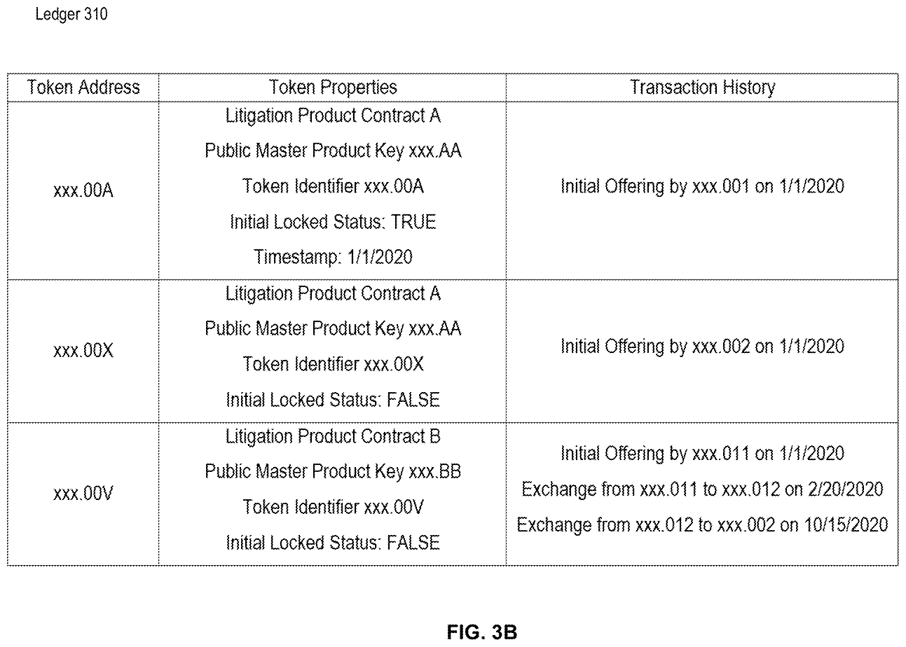

FIG. 2 is a schematic diagram of operations in the example computing environment. As described herein, the computing environment can be on the blockchain 102 or any other distributed ledger. Relevant parties in the computing environment can include a plaintiff (e.g., the party 116), non-accredited investors (e.g., the non-accredited investors 112A-N), and accredited investors (e.g., the accredited investors 110A-N). Secondary markets and associated secondary users can also be involved in the computing environment. For example, as described below, unlocked tokens can be traded in a marketplace or exchange (e.g., a secondary market, the exchange computing system 106) between existing token holders and secondary users (e.g., parties, entities, non-accredited investors, accredited investors, etc.).

As depicted, an initial offering of a token assigned to a litigation can be made to the accredited investors and/or the non-accredited investors. The initial offering can be for a stable coin and can have a one to one ratio with the token. In other words, one stable coin can buy the investor one token. When the initial offering is made, a sale registry and payment can be generated and stored in the ledger. The sale registry and payment can be linked to an address associated with the initial investor. Once the sale and payment occur, the token (e.g., initial litigation offering, “ILO,” token) can be issued and assigned to the initial investor. Issuance of the token can be performed by the creation/settlement system 104 as described herein.

At the time of issuing the token, the initial investor can be verified as an accredited investor. Verifying the initial investor can include various Know Your Customer (KYC) techniques for authenticating the investor (e.g., establishing the investor's identity and resources). Nodes of the blockchain 102 (e.g., the nodes 108A-N) can verify a status or accreditation of the investor, for example, by receiving authentication data associated with the investor from a third party data source that performs investor verification, and associating the authentication data with the investor's address. If the investor is not accredited (and/or if KYC has not been performed for the investor), then tokens issued to that investor are initially locked. Locked tokens cannot be traded in the marketplace or exchange for a duration of the lockup period. For example, tokens can be locked for one year from a time of issuance. Once the lockup period ends, the locked tokens can be unlocked by the nodes of the blockchain 102 and freely tradeable like any other digital assets or tokens.

When the initial investor is verified as accredited, tokens issued to that investor can be unlocked from the time of issuance. Thus, the unlocked tokens can be freely exchanged in the marketplace for a duration of the litigation or until a settlement event occurs in the litigation. In the marketplace, unlocked tokens can be bought and sold by existing token holders, investors, and other secondary users. Tokens that are exchanged in the marketplace can then be assigned to the secondary user's address. In other words, the exchanged token may no longer be assigned to the address of the initial investor.

The ledger can also keep track of genesis, or origin, token addresses. In some implementations, the genesis token addresses can associate the unlocked and locked tokens with the addresses of the initial investors. For example, if locked tokens are never traded in the exchange once the lockup period ends, the locked tokens are assigned to only the initial non-accredited investor's address, or the genesis token address. Likewise, if the unlocked tokens are never traded in the exchange during the life of the litigation, the unlocked tokens are assigned to only the initial offering accredited investor's address, or the genesis token address. As mentioned, tokens that are exchanged in the marketplace can be assigned to addresses of the secondary users, not the initial investors.

Trading of the tokens can occur for so long as the litigation exists or until there is a settlement event. For example, the plaintiff can receive a notification event at some time during the litigation. The notification event can be a settlement or some resolution. Notification of this event can be sent to all current token holders. The notification can be sent by the creation/settlement system 104. The current token holders can be identified based on identifying in the ledger which investor addresses are associated with the token. Therefore, all token addresses, including the genesis token addresses and the secondary user addresses, can be identified. Current token holders can be either the initial investors (e.g., indicated by the genesis token addresses) or the secondary users who purchased the tokens in the marketplace (e.g., indicated by the secondary user addresses).

After notifying the current token holders, a freeze event can be invoked. For example, the plaintiff can send a request to invoke the freeze event with a signature generated by a private master product key. The nodes of the blockchain 102 can verify the signature against a public master product key associated with each of the tokens assigned to the litigation. Once the signature is verified, the freeze event can be executed such that the tokens assigned to the litigation can be restricted from being further traded on any exchange.

Once settlement is completed and the litigation ends, the token can be paid out to the token holders. Payout can be made based on the frozen token addresses. In other words, initial investors and secondary users who were assigned the token immediately prior to the freeze event can receive payout of the token returns. Any trades that were attempted at a time of the freeze event, the settlement event, or after the freeze event may not count as valid transactions. Moreover, the freezing event can govern validity of these trades. Therefore, all of these trades can be deemed valid up until a time at which the freezing event occurs. Entities that were assigned the tokens before the freeze event occurs can receive token returns during settlement payout. If KYC has not previously been performed for a token holder (e.g., the token holder's investor address is not associated with investor verification data), KYC can optionally be performed before initiating a settlement payout for the token holder. For example, at the time of the freeze event, each unverified token holder can be notified that settlement payout for their tokens is not to occur before KYC is performed.

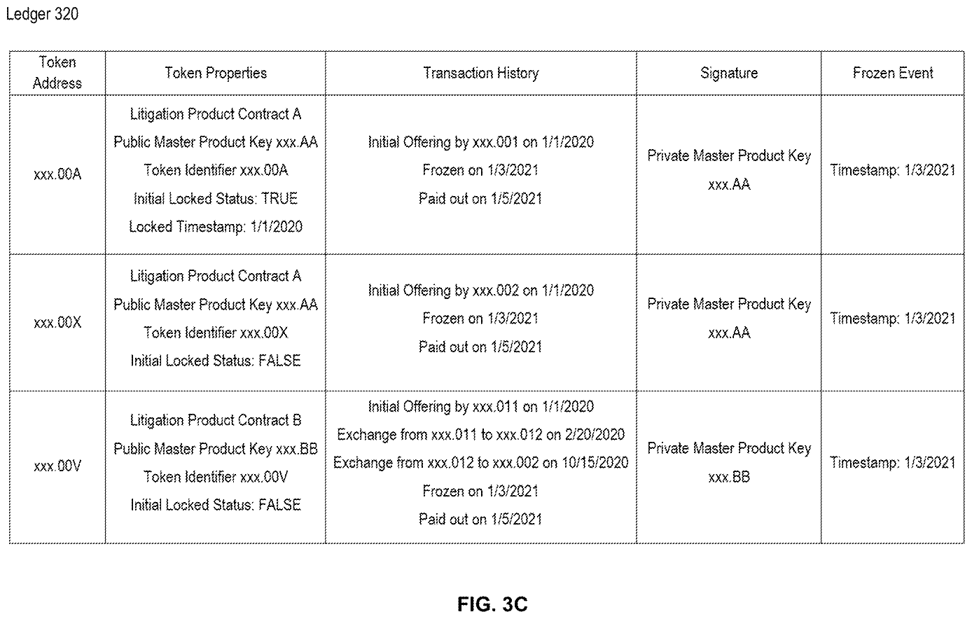

FIG. 3A depicts example token creation in a ledger 300. A judicial branch 301 can include a plurality of judicial court systems. In the judicial branch 301, litigations can arise, such as litigation A and litigation B. Litigation A and litigation B can be associated with different parties, law firms, and claims. As described throughout this disclosure, when litigation A arises, the associated law firm or party can notify the creation/settlement system 104 (e.g., refer to FIG. 1). The system 104 can then generate a litigation contract, a token, and a master product key (e.g., a public and private key pair) associated with litigation A. Litigation A can have a master product key of xxx.AA, as depicted in FIG. 3A. A private master product key xxx.aa can be retained by the law firm that seeks litigation funding for litigation A. A public master product key xxx.AA can be stored in the token ledger 300 and used by nodes of the blockchain to verify/validate locking, freezing, and settlement events for the litigation A. Moreover, the public master product key xxx.AA can be included in each token that is generated for the litigation. Likewise, when litigation B is created, the system 104 can generate a litigation contract, a token, and a master product key associated with litigation B. Litigation B can have a master product key of xxx.BB, as depicted in FIG. 3A. A private master product key xxx.bb can be retained by the law firm that seeks litigation funding for litigation B. A public master product key xxx.BB can be stored in the token ledger 300 and used by nodes of the blockchain to verify/validate locking, freezing, and settlement events for the litigation B.

Investors can make initial offers for the token of each of litigation A and litigation B. In other examples, initial offerings of the token can be made to investors (e.g., by the creation/settlement system 104 in FIG. 1). Each initiated token can have a token address that is assigned to the token holder (e.g., the initial investor) and associated with the master product key of the corresponding litigation. For example, tokens having the addresses xxx.00A, xxx.00Z, xxx.00Y, xxx.00X, and xxx.00P can be issued to initial investors of litigation A, which has the master product key xxx.AA. Likewise, tokens having the addresses xxx.00V, xxx.00R, xxx.00Q and xxx.00N can be issued to initial investors of the litigation B, which has the master product key xxx.BB. Thus, the same public master product key can be used for each token that is generated for the litigation. Any additional tokens that are initially offered for each of the litigations A and B can be assigned to one or more initial investors.

The token ledger 300 can include information such as investor addresses, token addresses, and public master product keys. As depicted, an investor having an address xxx.001 is assigned a token having an address xxx.00A. This token is associated with the public master product key xxx.AA, which is for litigation A. An investor having an address xxx.002 is assigned tokens xxx.00Z, xxx.00Y, and xxx.00X, all of which are associated with the public master product key of litigation A. The investor xxx.002 also is assigned a token xxx.00V, which is associated with the public master product key xxx.BB of litigation B. Thus, the investor xxx.002 has invested in both litigation A and litigation B. An investor having an address xxx.003 is assigned a token xxx.00P, which is associated with litigation A's master product key, and a token xxx.00R, which is associated with litigation B's master product key. Finally, in the example ledger 300, an investor having an address xxx.003 is assigned tokens xxx.00Q and xxx.00N, which are associated with litigation B's master product key.

Each of the investor addresses can have a public and private investor address. The investor addresses depicted in the ledger 300 can be the public investor addresses. The investors can each retain their private investor addresses. When an investor attempts to trade a token, the private investor address can be used to generate a signature. The signature can then be used by the nodes of the blockchain to verify that the investor in fact holds the token and to validate the token trade. Validating the token trade can include using the public master product key to determine whether the investor in fact is assigned the token and whether the token is locked or unlocked. Upon validation of the token trade, the token address can be assigned to a different investor address (e.g., a buying investor), which can be reflected in the ledger 300.

FIG. 3B depicts an example token ledger 310 when tokens are traded in a marketplace of the computing environment. The ledger 310 can include token addresses, token properties, and transaction history. For example tokens xxx.00A, xxx.00X, and xxx.00V, as described in reference to FIG. 3A, are depicted in the ledger 310.

The token properties of token xxx.00A indicate that the token is associated with litigation product contract A, which has the public master product key xxx.AA. The token's identifier (e.g., address) can also be included in the ledger 310 along with an initial locked status of the token and a timestamp of the initial locked status. Here, token xxx.00AA has an initial locked status of TRUE, which indicates that the token was initially offered by a non-accredited investor. The token was initially offered and locked on Jan. 1, 2020, the timestamp. Transaction history associated with token xxx.00AA indicates that the initial offering was by investor xxx.001 on Jan. 1, 2020. Investor xxx.001 is a non-accredited investor.

The token properties of token xxx.00X indicate that the token is associated with litigation product contract A, which has the public master product key xxx.AA. The token's identifier (e.g., address) can also be included in the ledger 310 along with an initial locked status of FALSE. This indicates that the token was initially offered by an accredited investor and the token can be freely exchanged on the marketplace. The associated transaction history indicates that the initial offering was by investor xxx.002 on Jan. 1, 2020. Although investor xxx.002 is accredited and can freely trade the token xxx.00X, the transaction history indicates that the investor xxx.002 has held onto the token xxx.00X.

The token properties of token xxx.00V indicate that the token is associated with litigation product contract B, which has the public master product key xxx.BB. The token's identifier (e.g., address) can also be included in the ledger 310 along with an initial locked status of FALSE. This indicates that the token was initially offered by an accredited investor and the token can be freely exchanged on the marketplace. The associated transaction history indicates that the initial offering was by investor xxx.011 on Jan. 1, 2020. The token xxx.00V was then traded on the marketplace on two more occasions. The token was exchanged from investor xxx.011 to an investor xxx.012 on Feb. 20, 2020. The token was then exchanged from investor xxx.012 to an investor xxx.002 on Oct. 15, 2020. Thus, the token xxx.00V is currently assigned to the investor xxx.002. Investor xxx.002 also has the token xxx.00X, which the investor initially offered at token creation. The tokens xxx.00A and xxx.00X have remained assigned to their respective initial investors, xxx.001 and xxx.002.

FIG. 3C depicts an example token ledger 320 at a settlement event in the computing environment. Tokens xxx.00A, xxx.00X, and xxx.00V, as described in reference to FIGS. 3A-B, and their associated token properties and transaction history are depicted in the ledger 320. A signature and frozen event timestamp can be added to the ledger 320 upon execution of a freeze event by nodes of the blockchain. The token properties can be immutable. However, the transaction history can be updated to reflect actions that occur in response to execution of the freeze event.

For example, the law firm associated with the litigation product contract A (e.g., litigation A) can receive a settlement and thus notify the creation/settlement system 104 (e.g., refer to FIG. 1). The creation/settlement system 104 can invoke a freeze event on all tokens associated with the litigation product contract A. The nodes of the blockchain can receive a signature from the law firm that is generated using the private master product key for litigation A. The nodes can verify that signature against the public master product key for litigation A before executing the freeze event.

In some implementations, a plurality of keys can be used to verify execution of the freeze event. For example the number of keys needed for verification can be based on when during the litigation the settlement event occurs and/or an amount of settlement in the settlement event. The plurality of keys can be a multi-sign. In other words, multiple parties can be required to verify or validate execution of the freeze event. For example, a multi-sign rule can require that two out of three parties must validate the freeze event execution. Any two of those three parties can validate the freeze event.

Once the signature is verified, the nodes can execute the freeze event. A timestamp for freeze execution can be generated and associated with each of the tokens. As a result of freeze execution, the tokens can no longer be exchanged on the marketplace. In some implementations, the freeze event can occur after the settlement event occurs. Thus, the tokens can be prevented from being exchanged as of the timestamp of the freeze event. In other examples, the tokens can be prevented from being exchanged as of a time of the settlement event, even if the tokens are frozen at a time later than the settlement event.

When a plurality of keys are used, the keys may act in a configuration where a threshold number (t) of the total keys (n) are required to take a desired action. For example, in a 2 out of 3 setting, 2 keys can be required to affect the desired action to a contract. In another example, other configurations, such as 3 out of 5, can be utilized in settings where the keys are in the custody of different parties. The threshold value (t) can determine a security of the contract, while a replication value (n) can determine the redundancy against failures in key storage and safekeeping. The default use of a single key can correspond to a 1 out of 1 setup, where there is a single replicated key and a single key threshold. Higher (n) values can make the system resilient against a custodian who loses their keys, while higher (t) values can make the system tolerate up to t−1 keys that may fall into the wrong hands.

As depicted in the ledger 320 of FIG. 3C, a settlement event occurred in both litigation A and litigation B on the same date (Jan. 3, 2021). Transaction history for tokens xxx.00A, xxx.00X, and xxx.00V were updated to indicate that each token was frozen on Jan. 3, 2021 and paid out on Jan. 5, 2021. Although not depicted in the ledger 320, one or more of the tokens can be frozen and/or paid out on different dates from the settlement event.

Moreover, as described further throughout this disclosure, token returns can be paid out once all the tokens associated with the litigation are frozen and the settlement event is completed. Before the tokens are paid out, token holders can be notified that there is a settlement event and that is why the tokens are frozen. Once the creation/settlement system 104 verifies that all associated tokens are frozen, the tokens can be paid out to each token holder that was assigned tokens prior to the freeze event. The tokens can be paid out in a stable coin or currency, such as the U.S. dollar.

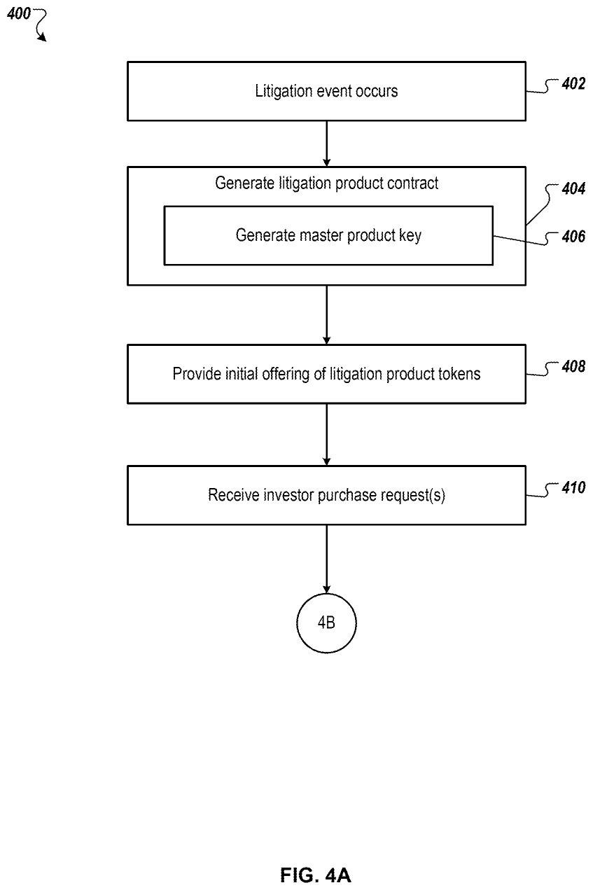

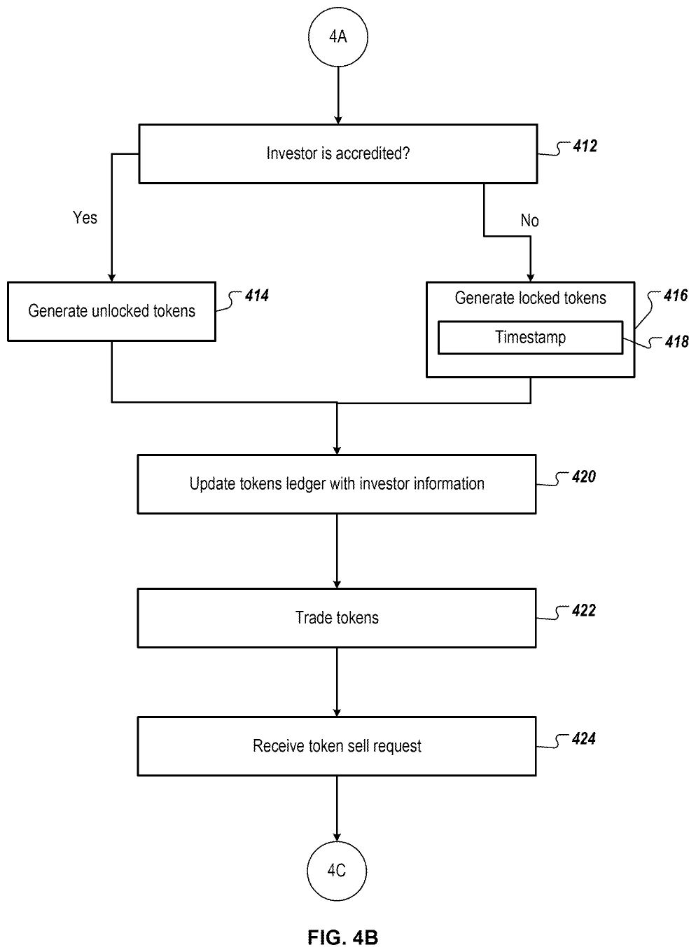

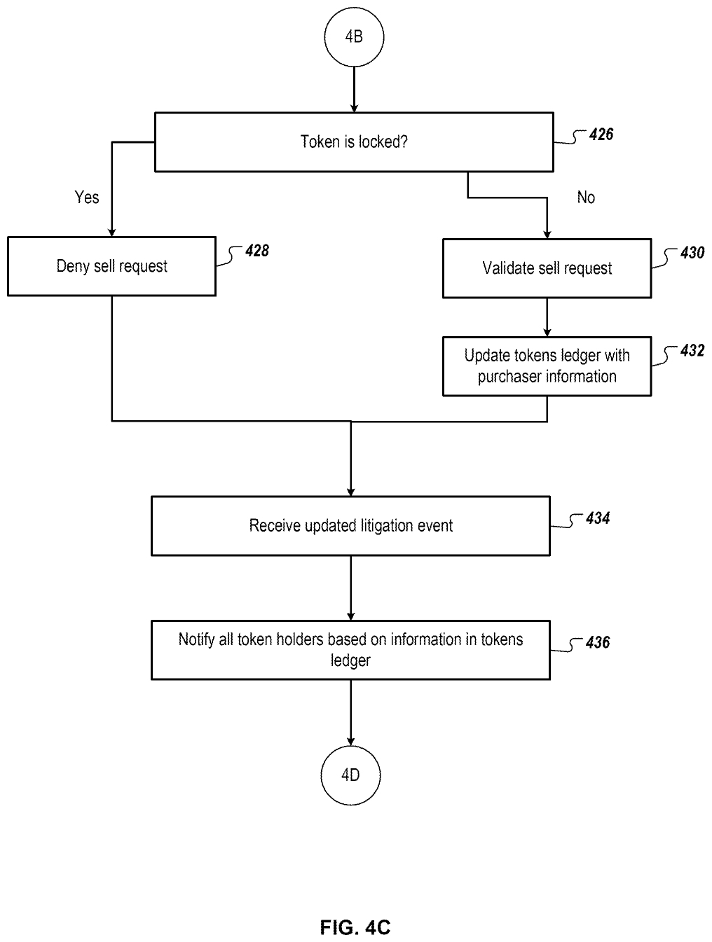

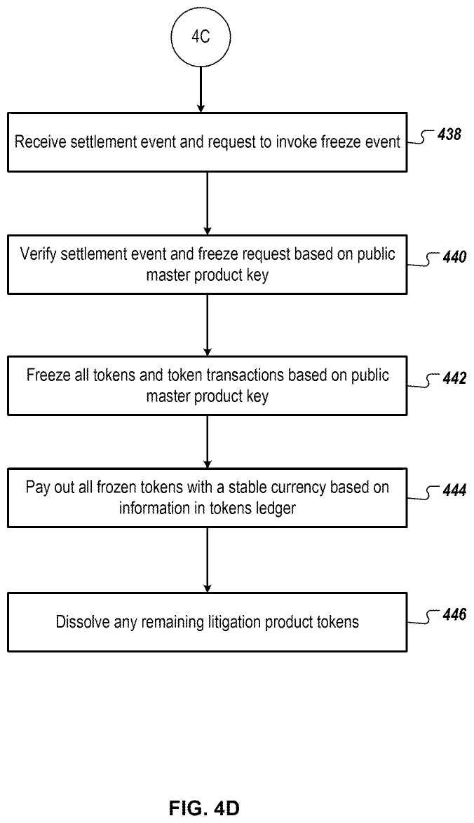

FIGS. 4A-D are a flowchart of a process 400 for operating the computing environment. The process 400 can be performed by one or more components of the computing environment as described herein, such as the creation/settlement system 104 and the exchange computing system 106 (e.g., refer to FIG. 1). Referring to FIGS. 4A-D, a litigation event occurs in 402. The litigation event can be a start of a lawsuit between two or more parties. A party in the litigation or a law firm representing the party in the litigation can provide a notification to the creation/settlement system 104 that the litigation event occurred. The notification can be a request to generate a token for that litigation, which can be traded in an exchange or marketplace (e.g., exchange computing system 106). By generating a tradeable token, the law firm can attract investors to invest in the litigation and raise necessary financial resources to pursue the litigation to its completion. The request can include a maximum quantity of tokens that the part or law firm wants generated and/or in circulation in the marketplace.

A litigation product contract can be generated in 404. Based upon the request to generate the token, the engine 104 can create a smart contract for the litigation event. The contract can include terms and conditions for trading the associated token (e.g., litigation product token) in the marketplace. The contract can also dictate token returns and rules concerning a freeze event, settlement event, and payout. Even more so, the contract can indicate a maximum number of tokens that can be generated and/or circulated in the marketplace.

For example, the contract can indicate that at certain milestones or stages in the litigation, token returns can increase by a certain percent or amount. Thus, the token can gain more value as the litigation continues and/or continues favorably for the requesting law firm or party.

As another example, the contract can indicate how many nodes of a blockchain and/or how many keys are required to validate the settlement event and execute the freeze event. In some implementations, a greater number of nodes and/or keys may be required to validate the settlement event when a settlement amount exceeds a minimum threshold value.

As yet another example, the contract can include payout rules. In some implementations, the rules can indicate that any overage in settlement amount goes to the law firm and/or the party. Therefore, investors may not receive overage returns in their payouts. In other implementations, the rules can also indicate that if the settlement amount is below a threshold amount or less than was anticipated at execution of the litigation product contract, then token returns are reduced. As an example payout rule, if there is a recovery, every holder of a particular litigation product token can be paid an equivalent of $2.50 for each of the token that they own. Thus, if an entity purchases 1,000 of the token, they can be entitled to $2,500 in the event there is a successful return in the litigation. The payout rules can also indicate what stable coin or currency will be used for paying out token returns. In some implementations, the same stable coin can be used to pay each of the token holders. In other implementations, the stable coin used can vary for each of the token holders based on the token holder's preference for payout and/or currency that the token holder used in purchasing the token(s).

As another example, the contract can indicate what types of notifications investors receive during a lifespan of the litigation. For example, current token holders (e.g., investors) can be notified at one or more milestones in the litigation, such as when a claim proceeds to trial, when a jury is impaneled, when court-related delays occur, and/or when there are settlements, arbitrations, mediations, a resolutions, or any other phase of the litigation. Moreover, one or more of these milestones can be monitored by the investors through public court filings. The milestone notifications can be generated based on receiving notice from the law firm. The milestone notifications can also be generated automatically based on the creation/settlement system 104 retrieving information from the public filings. Notifications can be provided to an investor directly through a wallet that is configured to interface with the blockchain (e.g., when notifications are recorded on the blockchain), a separate application or website, or both. The notifications described herein can benefit the investors because it can help them make decisions about whether to purchase more of a token associated with the litigation or to sell their token(s). The market for the associated token can remain liquid, value of the associated token can fluctuate, more entities can be inclined to invest, and more funds can be raised for the law firm.

Terms, conditions, and/or rules of the contract can be determined by the law firm and/or the creations/settlement system 104. For example, some rules, terms, and/or conditions can be boilerplate and used for similar litigation product contracts.

Moreover, a master product key can be generated (406). The master product key can be used when invoking the settlement event, freeze event, and payout event. The master product key can associate the litigation product contract with the litigation, the requesting law firm (or requesting party), and a token. A public master product key and a private master product key can be generated. The public master product key can be stored in a ledger (e.g., distributed ledger) for each generated token, as described herein. The public master product key can be immutable and can link each generated token to the associated litigation and litigation product contract. The private master product key can be held by the law firm. The private key can be used for generating a signature when the law firm seeks to invoke the settlement event, freeze event, and/or payout event. Nodes of the blockchain can validate the law firm's signature against the public master product key before executing the law firm's event request (e.g., before freezing all the tokens in a digital exchange).

Since the master product key does not itself hold sensitive, private, or valuable information, if the law firm loses the private master product key, the token for the litigation can be reissued and doled out to all current token holders and a new master product key can be generated. After all, the master product key is used mainly for invoking events that impact tradability of the token, such as settlement, freezing, and paying out.

An initial offering of litigation product tokens can be provided in 408. For example, entities in a marketplace (e.g., accredited investors 110A-N and/or non-accredited investors 112A-N in FIG. 1) can be notified that a new token is available for purchase. Entities can find out that a new token is available by the token description being available either on a blockchain (e.g., with token information being surfaced through a wallet configured to interface with the blockchain, or another suitable mechanism), or by having the description placed on a service such as a website dedicated to litigation product tokens or other assets. An initial pricing of the token can be set by a litigation and/or an issuing entity. The marketplace can be any exchange on a blockchain or other similar computing environment. In some implementations, the litigation product token can be introduced for initial offerings in multiple marketplaces or exchanges on multiple blockchains. As a result, more entities can invest in the token, thereby investing in the litigation, and assisting the law firm in raising the necessary financial funds to pursue the litigation to completion.

Investor purchase requests can be received in 410. An entity can make a request on the marketplace to purchase a quantity of the litigation product token. The purchase request can include the entity's signature. The entity can be any party that transacts in the marketplace. For example, the entity can be an individual, a company, another law firm, a litigation funding firm, etc. The entity can be an accredited investor, a non-accredited investor, a U.S. investor, and/or a non-U.S. investor. In some implementations, an exchange rate can be 1:1. As an example, an entity can request one litigation product token for one U.S. dollar. One or more other exchange rates can be established and used. For example, initial exchange rates can be determined by a litigant and/or issuing entity. In some implementations, the exchange rate can be different for every litigation product contract. The exchange rate can also be established and/or determined based on trends in the marketplace. Exchange rates can be fixed, or the rates can be determined through an order book. In an order book, sell and buy orders, corresponding to supply and demand for the tokens, can match at a market price.

Once the initial purchase request is received, it can be determined whether the investor (e.g., entity making the request) is accredited (412). Nodes of the blockchain can validate the investor's accreditation. As mentioned, the investor's purchase request can include the investor's signature. The nodes can verify the investor's signature against the investor's public address that is on the ledger. Verifying the signature can include identifying an accreditation status of the investor. Known techniques can be used to verify the investor's accreditation. For example, various Know Your Customer (KYC) techniques can be used for establishing the investor's identify and resources. In some implementations, verification data can be received by nodes of the blockchain from a third party data source that has performed KYC and/or determined an accreditation status for the investor. For example, the purchase request can include an identifier of the third party data source of the KYC and/or accreditation status of the investor, along with the investor's signature. In response to receiving the purchase request, for example, nodes of the blockchain can submit a query for the KYC and/or accreditation status of the investor to the third party data source. After receiving the KYC and/or accreditation status of the investor from the third party data source, the investor's status can optionally be stored by the blockchain in association with the investor's address.If the investor is accredited, then unlocked tokens can be generated in 414. Moreover, in some implementations, if the investor is a non-U.S. investor, unlocked tokens can be generated. If the investor offers $300 for 300 of the litigation product token, then 300 unlocked litigation product tokens can be generated and assigned to the investor. The investor can then freely trade those 300 tokens because they are unlocked. Unlocked tokens can be freely tradeable in the marketplace for a duration of the litigation or until a settlement event occurs in the litigation. Thus, unlocked tokens can be traded from the initial accredited investor to other accredited investors or even non-accredited investors. If a non-accredited investor receives an unlocked token, the token remains unlocked. This is because the token's locked status is determined at initial token generation and is an immutable property of that token. Therefore, accreditation of subsequent token holders does not change a locked status of the traded tokens.

If the investor is not accredited, then locked tokens can be generated in 416. Moreover, a timestamp can be generated for the time at which the initial locked tokens are generated (418). The locked status is an immutable property of these generated tokens. Thus, the locked status does not change until a predefined lockup period ends. The lockup period can be one year from a time at which the token is generated. During that lockup period, the locked tokens cannot be traded. These tokens can be held in a wallet of the initial investor. Determining whether the lockup period has ended can be based on the timestamp generated in 418. The initial locked status and timestamp can be accessible in the ledger and used by nodes of the blockchain to verify or deny a purchase or sale request for such tokens.

Once tokens are generated (414, 416), the ledger, as depicted and described herein (e.g., refer to FIGS. 3A-C), can be updated with the initial investor's information (420). The ledger can indicate that a token's address is assigned to the investor's address. The initial lock status of the generated token (e.g., locked or unlocked) can also be added to the ledger. The investor can receive the purchased tokens in their wallet. Information can be continuously added to the token ledger for the token whenever some event occurs that relates to the token, such as a lockup period ending, an exchange of the token with another entity, a freeze event, and/or a payout event.

In 422, tokens can be transferred from one investor to another investor, possibly in exchange for other assets (e.g., traded). As mentioned, the tokens can be traded in one or more different marketplaces operating on one or more different blockchains. An entity can attempt to trade both locked and unlocked tokens. As described below, where the entity attempts to trade locked tokens, the trade can be denied and the entity can receive a notification of such denial in their wallet. The litigation product tokens can be traded for other litigation product tokens, stable coins or currencies, and/or other digital assets and blockchain-based products that are tradeable in the marketplace. Such liquidity and tradability can increase a value of the litigation product token and encourage more entities to invest in the litigation associated with that token. The value of the litigation product token can also fluctuate based on marketplace changes, other currencies or digital assets, and/or occurrences of milestones in the litigation (e.g., a token can be initially sold for $1 and once the law firm survives a motion to dismiss in the litigation, the token sale price can increase to $1.50).

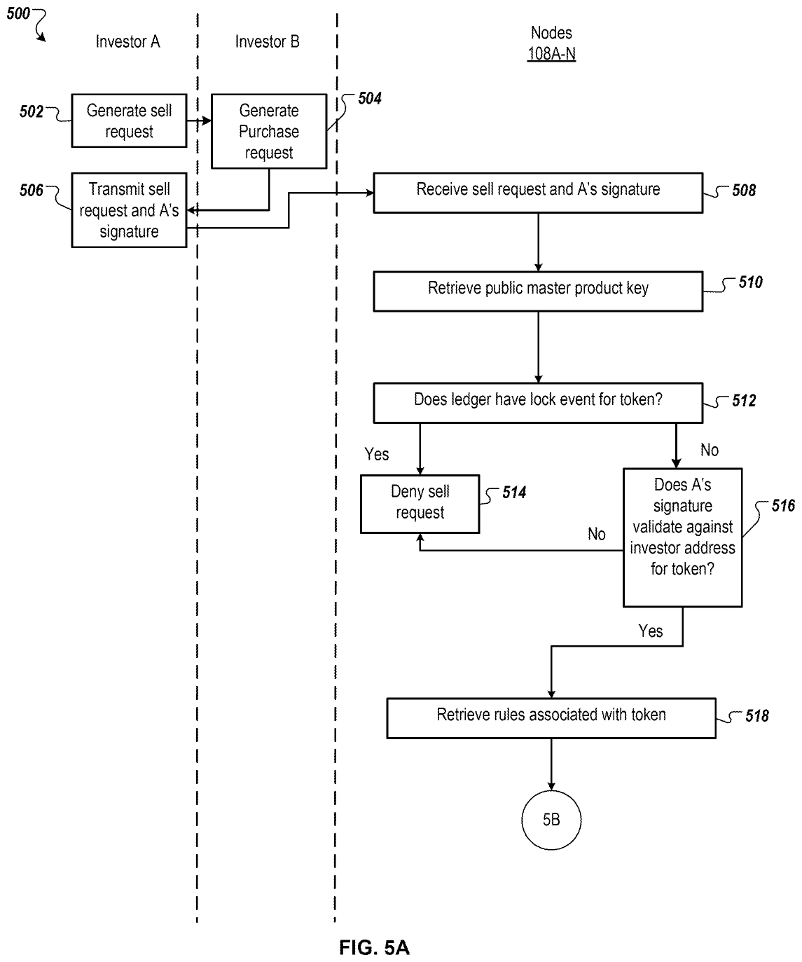

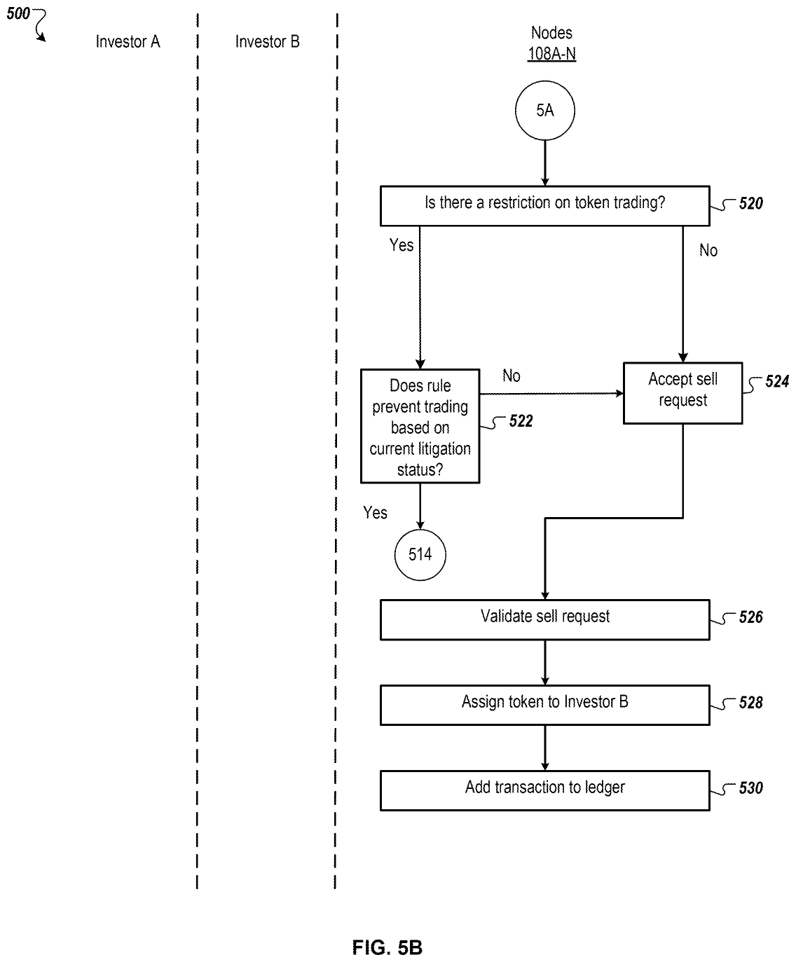

A token sell request can be received in 424. For example, the creation/settlement system 104 can receive the request. The request can originate from the initial investor and/or a subsequent holder of the token. As described further below (e.g., refer to FIGS. 5A-B), the sell request can include a signature of the requester, a signature of the entity seeking to purchase the token, the token address, and the public master product key.

Next, it can be determined whether the token is locked (426). Using the token address, the creation-settlement system 104 can identify the properties of the token corresponding to the sell request, on the ledger. As mentioned above, the initial lock status of each token can be identified on the ledger. If the token corresponding to the sell request was initially locked, then the timestamp can indicate when the lockup period began. If the lockup period has ended, then the token is no longer locked and therefore tradeable. If the lockup period is still going, then the token is locked and therefore not tradeable. If the token does not have an initial lock status, then it is immediately tradeable.

If the token is locked, then the sell request can be denied in 428. A notification can be generated and sent to the sell requester's wallet that the transaction was denied or failed.

If the token is unlocked, the sell request can be validated in 430. Known techniques, using generated signatures and public keys/addresses, can be employed to verify the seller and the purchaser. Validating the sell request can include completing the transaction and transferring the litigation product token from the seller's wallet to the purchaser's wallet. In other words, the litigation product token can now be assigned to a new token holder. When the token is assigned to the new token holder, the new token holder can also receive the associated litigation product contract. Therefore, the token holder can be aware of any terms, conditions, and/or rules associated with holding the litigation product token. The new token holder can monitor progress of the litigation (e.g., via public court filings and/or notifications generated and provided by the law firm and/or the creation/settlement system 104) to determine whether to hold onto or trade the purchased token(s).

The token ledger can be updated with purchase information (432). For example, the purchaser's public address can be associated with the token's address. Transaction information can also be added to the ledger (e.g., refer to FIG. 3B). The transaction information can include a timestamp indicating when the transaction occurred/was completed and/or addresses of each of the transacting parties. The purchased token is merely transferred to or assigned to a new token holder, as mentioned above. Therefore, the new token holder takes the token with whatever properties it has and the properties of the token do not change. For example, even if the new token holder is a non-accredited investor, the token itself remains an unlocked token because at the initial offering, the token was generated for an accredited investor. Thus, the token remains freely tradeable in the marketplace and a subsequent non-accredited investor can purchase and sell the unlocked token. The initially unlocked token will not enter a lockup period upon being purchased by a subsequent non-accredited investor.

The litigation product token can be traded and circulated in the marketplace for a lifespan of the litigation. At any point during the litigation's lifespan, an updated litigation event can occur. When such an event occurs, the creation/settlement system 104 can receive a notification from the law firm (434). As some non-limiting examples, the updated litigation event can be the entering of a new phase in the litigation, a change in parties, a change in claims, or any other milestones that can occur during a lawsuit. In some examples, as described below, the updated litigation event can be a settlement, resolution, or some other form of closing negotiations. In some implementations, the system 104 can identify that a litigation event occurred based on automated monitoring and/or review of public filings.

Current token holders can be notified of the event in 436. To determine the investor addresses to send a notification to, nodes of the blockchain can verify against the ledger what token addresses are assigned to which investor addresses. The notification can be generated based on rules outlined in the litigation product contract. The notification can also be sent to wallets of the current token holders based on rules outlined in the litigation product contract.

A settlement event and request to freeze event can be received in 438. In other words, some form of resolution can occur in the judicial branch, between parties to the litigation. The law firm can then provide a notification of this settlement event to the creation/settlement system 104. The notification sent by the law firm can also include a request to freeze event. As described throughout this disclosure, the freeze event can be executed by nodes of the blockchain to freeze all trade of the associated litigation product token upon the happening of a settlement event. The notifications can be performed by the law firm or a designated oracle (e.g., node, state server). The oracle can be configured to import facts or information from an external world into a blockchain. The oracle can therefore report on information. Thus, the oracle can carry out a function where the contract/tokens switch states.

The settlement event can be the same litigation event in 434 or it can be a different event that occurs at a different time. Optionally, and as in 436, the current token holders can be notified of the settlement event.

Before the associated tokens can be frozen, the settlement event and request to freeze can be verified in 440. For example, the creation/settlement system 104 can determine whether the settlement event actually constitutes a settlement event. This determination can be made based on terms or conditions in the litigation product contract. For example, the contract can indicate that a valid settlement event is when the parties to the litigation begin negotiations for a recovery that exceeds a minimum threshold amount. Thus, even if negotiations for settlement have begun, if the negotiations involve a recovery amount that is less than the minimum threshold amount, then the litigation product token can continue to be traded in the marketplace.

The creation/settlement system 104 can also verify whether the law firm sending the notification is authorized to invoke the freeze event. As mentioned, the law firm holds the private master product key. When the law firm sends the notification and freeze request in 438 to the creation/settlement system 104, the notification can include a signature of the private master product key. Nodes of the blockchain can match the received signature with the public master product key, which lives or is accessible on the ledger. If the signature matches the public master product key, then the nodes can verify the law firm. Verifying the law firm means that the law firm is authorized to invoke the freeze event. Where the signature does not match the public master product key, the law firm can be notified that the request to invoke the freeze event is denied. Therefore, the litigation product token can continue to be traded in the marketplace, even if the law firm notified the engine 104 of a valid settlement event.

The litigation product can set out additional rules for verifying that the law firm is authorized to invoke the freeze event. In some implementations, the contract may require one or more law firms or other parties to send requests to invoke the freeze event. For example, the law firm and the adverse party can be required to send requests with the notification of the settlement event. The nodes of the blockchain can then validate signatures of both the law firm and the adverse party before executing the freeze event. In other implementations, the contract can require a minimum number of parties, entities, or law firms to provide their signatures to invoke the freeze event. If the minimum number of signatures are not provided and validated, then the freeze event may not be executed. In yet other implementations, the contract can require a certain number of nodes to check and validate the signature against the public master product key. If the signature is validated by a number of nodes that meets the threshold minimum number of nodes, then the freeze event can be executed.

Thus, once the settlement event is verified, the freeze event can be executed by nodes of the blockchain (442). Each of the nodes can receive instructions for executing the freeze event. The instructions can be added to the ledger or blockchain. Freezing all litigation product tokens associated with the litigation can involve modifying the blockchain to ensure that none of these tokens can be moved, modified, or used in any transactions in the marketplace. Any transactions that are attempted at a time that the freeze event is executed can also be frozen. Thus, the token(s) in the frozen transactions would remain assigned to the investor holding the tokens before the transaction can ever be executed. Moreover, the associated tokens that reside in an investor's wallet can be frozen in the wallet such that the investor cannot attempt a transaction with those tokens, or that an attempted transaction would be rejected. Freezing the litigation product token is advantageous to ensure that token returns can be paid out according to the litigation product contract once the settlement is complete and the litigation ends. Freezing the litigation product token is also advantageous to prevent investors from rapidly buying or selling the token based on the settlement event or outcome of the settlement event.

To freeze the litigation product token, the nodes can match the public master product key with token addresses on the ledger. As mentioned, all litigation product tokens associated with a particular litigation are assigned the same public master product key. Therefore, one public master product key can be used to freeze all associated tokens, which is advantageous to fix an owner pool so that token returns can be distributed.

Once the freeze event has been executed by nodes of the blockchain, the ledger can be updated with information about the freeze event's execution. For example, for each token that has been frozen, the corresponding token address can be given a freeze timestamp, which indicates a time at which the token was frozen. In some implementations, all the associated tokens can be frozen at the same time. In other implementations, one or more of the associated tokens can be frozen at different times (e.g., refer to FIG. 3C). Freezing the litigation product tokens at a token level is advantageous, as it ensures that particular tokens associated with a particular litigation product can be restricted from being transferred, while not limiting the transfer of other tokens associated with other litigation products. That is, individual investor addresses are not being frozen, only particular tokens held by the investors.

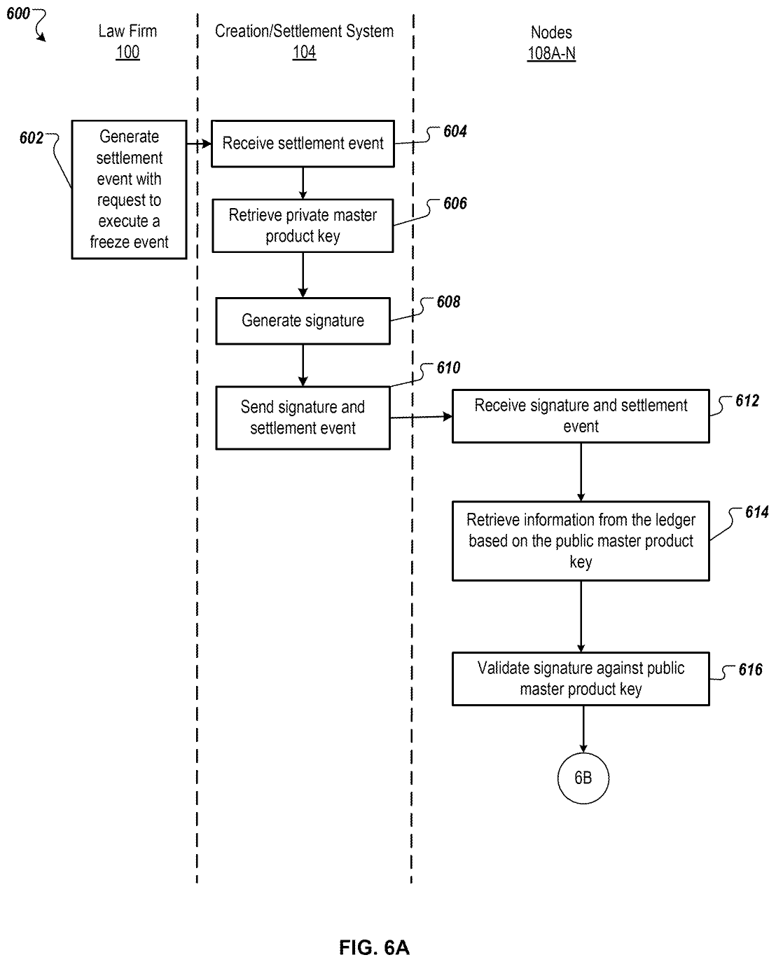

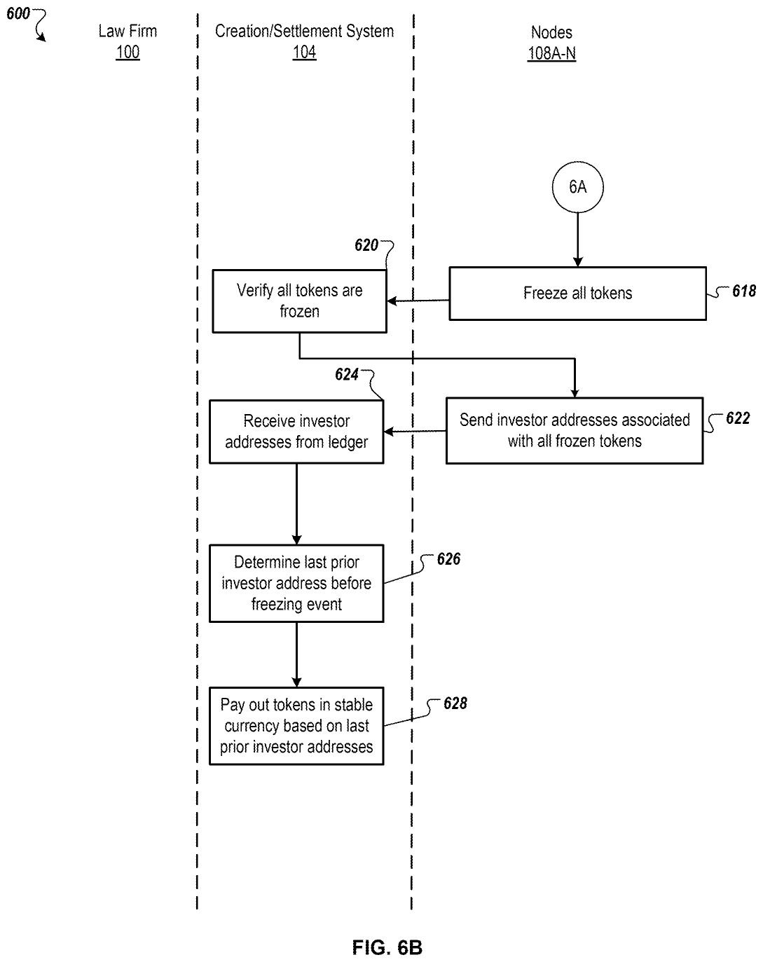

Frozen tokens can be paid out with a stable currency in 444. This can be performed by the creation/settlement system 104 and/or the nodes of the blockchain. As described below (e.g., refer to FIGS. 6A-B), the engine 104 can verify that the tokens are in fact frozen. This can be accomplished by checking the public master product key with the token addresses to determine whether the associated tokens have frozen timestamps. Moreover, the tokens may not be paid out until the settlement event is over and/or the litigation ends. In other words, payout may not occur until the law firm has settlement funds in escrow. The law firm can also hold the settlement funds in escrow until it is verified that all the associated tokens are frozen.

The token returns can be paid out according to one or more rules of the litigation product contract created in 404. In determining who to send the token returns to, the creation/settlement system 104 can identify what token addresses are assigned to which investor addresses on the ledger. The investor addresses that are associated with the token addresses just prior to execution of the freeze event can receive the token returns. Therefore, if a transaction was occurring during execution of the freeze event, the transaction would not be completed and the token(s) would remain assigned to the investor who tried selling their token(s) in that transaction. In this example, the investor who made the sell request would receive the token returns at payout. In some implementations, a determination of whether an investor has been identified (e.g., through a Know Your Customer (KYC) technique) can be performed, before providing token returns to the investor. For example, the creation/settlement system 104 can access the blockchain to determine whether KYC has previously been performed for the investor (e.g., the investor's address is associated with verification data received from a third party data source that performs investor verification), and if so, token returns can be provided to the investor. If KYC has not been previously performed for the investor (e.g., the investor purchased tokens on a secondary market without having performed KYC), a notification can be provided to the investor (e.g., through an interface of a wallet that is configured to interface with the blockchain) that the investor is to undergo KYC before token returns can be provided to the investor. The notification can include a mechanism for accessing a third party service that performs KYC, and once KYC has successfully been performed by the service, another notification can be provided to the investor that token returns are available for payout.

As mentioned, the token returns are paid out in a stable currency. For example, the settlement can occur in a USD denominated stablecoin (e.g., USDC). In other implementations, a litigant and/or issuing party can choose to offer interest and settlement in a different currency. That currency can then be used to pay out the token returns.

Any remaining litigation product tokens can be dissolved in 446. For example, if any tokens are in circulation in the marketplace but have not been assigned to any investors or entities by a time of executing a freeze event, then such tokens can be removed from circulation. The litigation product token itself can be dissolved since the litigation has ended and litigation funding is no longer required. Thus, the token would no longer have value. No investors or other entities can purchase or sell the token in any marketplace on the blockchain.

The process 400 depicted in FIGS. 4A-D can be repeated for every litigation where funding is required or requested. Therefore, a new and unique token can be generated for each litigation. Once a litigation ends, the token can be dissolved and a new token can be generated for the next litigation. Each token can also have different properties, as described throughout this disclosure.

FIGS. 5A-B are a swimlane diagram of a process 500 for exchanging tokens in the computing environment. As depicted, one or more steps in the process 500 can be performed by one or more different entities in the computing environment. Some steps can be performed by investors, such as the example investor A and investor B. Steps can also be performed by the nodes 108A-N of the blockchain (e.g., refer to FIG. 1). The investors A and B can be different entities that are transacting digital assets in any marketplace on the blockchain. The investors A and B can be anonymous and identifiable only by their signatures (e.g., investor addresses). The investors A and B can be at computing devices (e.g., mobile device, smartphone, laptop, tablet, computer, network of computers, a node, one or more nodes, etc.) that are in communication (e.g., wired and/or wireless) with each other, the nodes 108A-N, an exchange, marketplace, or any other platform, software, or system in the disclosed computing environment. Any one or more of the steps in the process 500 can be performed by one or more other engines or components of the computing environment as described throughout this disclosure (e.g., the creation/settlement system 104).

Referring to FIGS. 5A-B, investor A can generate a sell request in 502. The sell request can be made in the exchange or marketplace (e.g., the exchange computing system 106 in FIG. 1). At an initial offering, investor A can be the law firm that seeks funding. Therefore, the sell request can be an initial offering to sell tokens for investor A's litigation to investors in the marketplace. After the initial offering, once tokens for the litigation are generated and assigned to initial investors, investor A can be an initial investor or any other entity that purchased the token(s) after the initial offering and generation.

Investor A's sell request can be made directly to investor B. In other examples, the sell request can be made and broadcasted throughout the marketplace for any other entities, such as investor B, to respond to with a purchase request. The sell request can include the token address and the master product key. The sell request can also include the exchange price or rate for the token.

Investor B can generate a purchase request in 504. In other words, investor B can decide that they want to purchase or buy the litigation product token from investor A. The purchase request can include investor B's signature and currency or digital asset type that investor B would use to purchase the token.

Investor A can transmit the sell request and investor A's signature to the nodes 108A-N of the blockchain in 506. Investor A's signature can be used by the nodes 108A-N to verify investor A's identity and authority over the token in the sell request (e.g., the token is assigned to investor A, the token is unlocked and tradeable, the token is not frozen). In some implementations, this step can occur before the purchase request is received in 504. For example, the nodes 108A-N can determine whether investor A is allowed to sell their token(s) (e.g., the tokens are locked) before permitting the sell request to be broadcasted to entities in the marketplace. This can be advantageous to prevent transactions from being attempted and denied further down in the process 500. This can also be advantageous to improve efficiency for the nodes 108A-N in verifying and validating other transactions in the marketplace. In other implementations, as depicted in FIGS. 5A-B, 506 can occur after the purchase request is received (504). This can be advantageous to ensure that the nodes 108A-N do not spend time verifying sell requests that may not even be met by entities seeking to purchase the tokens.

The nodes 108A-N can receive the sell request and investor A's signature in 508. In some implementations, all the nodes 108A-N operating the marketplace can receive the sell request and signature. In other implementations, a predefined number of the nodes 108A-N can receive the request and signature. For example, the litigation product contract associated with the token in the sell request can indicate that a minimum number of nodes should receive the request and signature and thus verify and validate both. As another example, the litigation product contract can be silent on how many nodes receive the request and signature but can require the request and signature to be validated by a minimum number of the receiving nodes. In yet other implementations, the marketplace can set the rules about how many nodes receive the request and signature and/or validate both.

The nodes 108A-N can be programmed to retrieve a public master product key from the ledger in 510. Where the sell request includes the token address, the nodes 108A-N can use the token address to look up the associated public master product key in the ledger. As described throughout this disclosure (e.g., refer to FIGS. 3A-C), each token address can be associated with a litigation product contract via the same public master product key. The private master product key is held by the law firm or party seeking litigation funding while the public master product key is on the ledger with each token. The public master product key can be used to determine immutable properties of the token, terms and conditions for trading the token in the marketplace, and/or rules for trading, freezing, and paying out the token.

The nodes 108A-N can determine whether the ledger indicates that a lock event exists for the token in the sell request (512). In other words, the nodes 108A-N can determine whether the token is set to an initial locked status. As described throughout this disclosure, the token is locked from a time of its initial offering/generation if the token's initial investor is non-accredited. The token then remains in the lockup period for one year from the time of initial offering/generation. The lock event that is identified from the ledger in 512 can be the initial locked status. The nodes 108A-N can use the token address to search the ledger for the token's properties. The initial lock status of the token is an immutable property that can be stored on the ledger and thus searchable. The nodes 108A-N can also check a timestamp of the initial lock status to determine whether the lockup period has ended. After all, the token can have an initial locked status but the token's transaction history can indicate that the token has been unlocked since a time that is one year from the time of initial offering/generation. In that case, the token would be unlocked, or would not currently have the locked event. The nodes 108A-N can also use the public master product key associated with the token to search for the tokens having the locked event or the tokens that do not have the locked event.

If the token has the lock event, then the sell request can be denied in 514. This indicates that the token was initially offered and generated for a non-accredited investor. The token is locked for a lockup period of one year from the time of initial offering/generation. Because the token is locked, investor A (e.g., the initial investor) cannot trade the token to any entity in the marketplace for a duration of the lockup period. When the request is denied, a notification can be sent to investor A's wallet. A notification can also be optionally sent to investor B's wallet.

If the token does not have a lock event, then the nodes 108A-N can determine whether investor A's signature is validated against the investor's address for the token (516). The token is unlocked, which means it is freely tradeable in the marketplace. This also indicates that the token was initially offered and generated for an accredited investor. That accredited investor can be investor A. Investor A can also be any subsequent purchaser of the token. The nodes 108A-N check investor A's signature against the investor's address to ensure that the token is in fact assigned to investor A, that investor A has authority of the token, and that investor A is not a hacker or other malicious entity.

The nodes 108A-N can use the public master product key to identify, on the ledger, the token address of the token, and what investor address the token is assigned to. Transaction history for that token can indicate what investor currently holds the token. If the investor address does not match investor A's signature, then investor A is not authorized to sell the token. In such a situation, investor A can be a hacker or other malicious entity in the marketplace. If the investor address does match investor A's signature, then investor A is in fact the current holder of the token and therefore authorized to trade that token.

If investor A's signature does not validate against information about the token (e.g., transaction history, assignment of the token address to a particular investor address) on the ledger, then the sell request can be denied (514). As mentioned above, investor A and optionally investor B can receive a notification in their wallets that the sell request was denied. The token remains in the wallet of the current token holder (e.g., the investor address associated with the token address on the ledger).

If investor A's signature does validate against information about the token on the ledger, then the nodes 108A-N can retrieve rules associated with the token in 518. The nodes 108A-N can use the public master product key to identify the rules from the ledger. The rules can exist in the litigation product contract, which is identifiable via the public master product key. One or more different rules, terms, and/or conditions can apply to the token and outlined in the litigation product contract, as described throughout this disclosure. Such rules, terms, and/or conditions can limit the ability of investor A to sell the token in the marketplace. For example, a rule can set a minimum price that the token can be sold for in the marketplace. Therefore, if investor A's sell request does not meet the minimum price, the sell request can be denied. As another example, a rule can indicate what stable coins or other digital assets are acceptable as a trade for the token. Thus, if investor B is trying to purchase the token with a digital asset that is not permitted by the rule, then the sell request can be denied. Applicable trading rules can be determined by the law firm to the litigation product contract, the marketplace, existing U.S. securities laws, and/or the creation/settlement system 104.

Based on the retrieved rules, the nodes 108A-N can determine whether there is a restriction on token trading (520). Restrictions on token trading apply to all tokens that are associated with the public master product key (e.g., the litigation product contract). An example restriction can be invocation and execution of the freeze event. When the freeze event is invoked by the law firm and executed by the nodes 108A-N, all tokens associated with the litigation having a settlement event are frozen. As a result, none of the associated tokens can be moved in the marketplace. Restrictions on token trading can be determined by the law firm to the litigation product and/or the creation/settlement system 104.

If there is a trading restriction, then it can be determined whether the rule prevents trading based on the current litigation status in 522. The current litigation status can be a phase or stage of the litigation such as a settlement event, beginning of negotiations for a resolution, arbitration, mediation, close of a trial, etc. The law firm can determine what current litigation status can restrict trading of the associated token. For example, the law firm can determine that if settlement negotiations begin, these negotiations do not act as a restriction on trade unless the negotiated settlement amount is above a predefined threshold amount. As another example, the law firm can determine that if settlement negotiations begin, these negotiations do not act as a restriction on trade unless a chance or likelihood of recovery for the law firm exceeds a predetermined threshold amount (e.g., if the law firm has a 70% chance of succeeding in the settlement negotiations, then this current litigation status can act as a restriction on trade). In other implementations, the creation/settlement system 104 can determine what current litigation status acts as a restriction on trade (e.g., the same type of current litigation status can restrict trading for all litigation product contracts). Additionally, one or more statuses of the litigation can act as restrictions on trade.

In some examples, the law firm can provide the creation/settlement system 104 with a notification or indication of the current litigation status. In other examples, the nodes 108A-N can be configured to retrieve the current litigation status from public filings and/or the law firm in order to determine whether the restriction on trading should be invoked.

If the rule prevents trading based on the current litigation status, then the sell request can be denied (514). In other words, the current litigation status can be a settlement event. All associated tokens are frozen in token holder wallets, the marketplace, and any concurrent transactions, which means that the sell request cannot be executed, even if the sell request was made immediately prior to the freeze event being executed on the associated token. In some implementations, investor A can make a sell request without knowing the current litigation status or that a settlement event has occurred in the litigation. In other implementations, investor A can receive a notification in their wallet that a settlement event has occurred and that all associated tokens are frozen. In such a situation, investor A may not generate a sell request. In such a situation, investor A can still generate a sell request but that request can be denied, as described herein, in reference to FIGS. 5A-B.

As described above, investor A and optionally investor B can receive a notification indicating that the sell request is denied in 514. The notification can optionally include information about the current litigation status and/or the reason for denying the sell request (e.g., a settlement event has occurred and all trading of the associated token is suspended).

If the rule does not prevent trading based on the current litigation status, then the sell request can be accepted in 524. For example, the litigation can be entering a new phase of a trial or preparation for the trial. Such a phase may not be a settlement event or some other event that would require halting all trade of the associated token. Thus, in 524, a sell request is accepted when the token is unlocked (e.g., not in a lockup period, refer to 516) and freely tradeable (e.g., litigation is still ongoing, litigation is not in a settlement phase).

Once the sell request is accepted, the request can be validated in 526. As described throughout this disclosure, validating the request can include checking investor A's signature against the public master product key on the ledger to ensure that investor A holds the token. Validating the request can also include identifying investor B's wallet via investor B's address, which can be included in the sell request.

The token can then be assigned to investor B in 528. This can include sending the token to investor B's wallet and/or assigning the token to investor B's wallet. As a result, the token can be removed from investor A's wallet. Assigning the token to investor B can also include transferring investor B's digital assets from investor B's wallet to investor A's wallet in exchange for the token.

The transaction can be added to the ledger in 530. For example, transaction history for the token can be updated to reflect the purchase and sale described in reference to FIGS. 5A-B (e.g., refer to the ledgers in FIGS. 3A-C). The transaction history can include a timestamp indicating when the transaction occurred and/or was completed. The transaction history can also indicate investor A's address and investor B's address. Moreover, the token address can be assigned to or associated with investor B's address. As a result, investor A may no longer have access to the litigation product contract or the token because investor B has stepped into the shoes of investor A as the current token holder.

The process 500 depicted in FIGS. 5A-B can be repeated for every litigation product token, regardless of which litigation the token is associated with.

FIGS. 6A-B are a swimlane diagram of a process 600 for paying out tokens at a settlement event in the computing environment. As depicted, one or more steps in the process 600 can be performed by one or more different entities in the computing environment. Some steps can be performed by the law firm 100. Steps can also be performed by the creation/settlement system 104 and/or the nodes 108A-N of the blockchain. Any one or more of the steps in the process 600 can be performed by one or more other engines or components of the computing environment as described throughout this disclosure.

Referring to FIGS. 6A-B, the law firm 100 can generate a settlement event in 602. As described throughout this disclosure, a settlement event can occur in the litigation. The law firm 100 can then provide a notification of this settlement event to the creation/settlement system 104. The generated settlement event can include a request to execute a freeze event on all tokens associated with the litigation.

The creation/settlement system 104 can receive the settlement event in 604. Next, the creation/settlement system 104 can retrieve the private master product key in 606. The private master product key can be maintained by the law firm 100. As an example, the creation/settlement system 104 can request the law firm 100 to send the private master product key.

The creation/settlement system 104 can then generate a signature of the private master product key in 608. The signature can be generated using known techniques. In some implementations, signature generation can be performed by the law firm 100. However, in example implementations, the law firm 100 is in communication with a third party service provider that is configured to generate litigation product contracts (e.g., smart contracts), tokens, and other blockchain-based services for entities like the law firm 100. The creation/settlement system 104 can be such a third party service provider.

The signature and settlement event can be sent to the nodes 108A-N in 610. Thus, the creation/settlement system 104 can communicate a request that the nodes 108A-N execute the freeze event.

Each of the nodes 108A-N can receive the signature and settlement event in 612. As described throughout this disclosure, a predetermined number of the nodes 108A-N can receive the signature and settlement event.

The nodes 108A-N can retrieve information from the ledger based on the public master product key in 614. For example, the settlement event can include a copy of the public master product key. The nodes 108A-N can use this copy of the key to identify information on the ledger that is associated with the key. Using the copy of the key, the nodes 108A-N can access an associated litigation product contract and/or properties of associated tokens.

In 616, the nodes 108A-N can validate the signature against the public master product key in 616. For example, the nodes 108A-N can pull or identify the law firm 100's public address from the litigation product contract to see whether the law firm 100's signature matches that address. In so doing, the nodes 108A-N can ensure that the law firm 100 is authorized to report the settlement event and request to invoke the freeze event. As described throughout this disclosure, in some implementations, more than one signature may be required from different law firms or entities (e.g., required by the litigation product contract and/or by the creation/settlement system 104) in order to verify that the law firm generating the settlement event is authorized to invoke the freeze event. In such an example implementation, the nodes 108A-N can request signatures from the one or more other law firms or entities before being able to validate the law firm's signature in the settlement event.

Once the signature is validated, the nodes 108A-N can be programmed to freeze all tokens associated with the public master product key in 618. The nodes can use the public master product key to identify associated token addresses on the ledger. When the public master product key is invoked to freeze the associated token addresses, the nodes in the network can check the freeze condition next time an entity tries to move an associated token. Therefore, when frozen, if an entity attempts to move an associated token, the nodes can check IF the master product key for this token has frozen funds, THEN no action will be returned (e.g., the request to move the associated token can be denied).

Once all the associated token addresses are identified, they can be frozen. In other words, the blockchain or ledger can be modified to put a lock on all the associated tokens. Once frozen, the tokens can no longer be moved from a wallet or traded in the marketplace. Any transactions involving these tokens that occur at a time of executing the freeze event can also be halted. Therefore, the tokens would remain with the token holder that is trying to sell their tokens. Parties to the attempted transactions can be notified (e.g., by the creation/settlement system 104) that the transaction is denied because of the settlement event and execution of the freeze event.

The creation/settlement system 104 can verify that all associated tokens are frozen in 620. An amount of time can pass between execution of the freeze event in 618 and verifying frozen status of the tokens in 620. For example, the creation/settlement system 104 may not verify that all tokens are frozen until the nodes 108A-N send a notification to the system 104 that execution of the freeze event is complete. As another example, the creation/settlement system 104 can also ping the nodes 108A-N by asking for or requesting a status update on execution of the freeze event. In other implementations, 618 and 620 can be performed simultaneously. For example, the creation/settlement system 104 can verify that each associated token is frozen as the nodes 108A-N execute the freeze event.

Once all tokens are verified to be frozen, the nodes 108A-N can send investor addresses associated with all the frozen tokens to the creation/settlement system 104 (622). The nodes 108A-N can use the public master product key to identify the associated token addresses on the ledger. As described throughout this disclosure, the ledger can also include transaction history, which links or associates the token addresses with investor addresses. These investor addresses can be collected and sent to the creation/settlement system 104. In some implementations, the nodes 108A-N can send all investor addresses that are recorded in the transaction history of an associated token address. Thus, the sent investor addresses may include addresses of investors that were prior token holders but not current token holders. In other implementations, the nodes 108A-N can send only the most recent investor address that is recorded in the transaction history for the associated token address. For example, the nodes 108A-N can send the investor addresses for each associated token address that were part of the ledger just prior to execution of the freeze event.

The creation/settlement system 104 can receive the investor addresses from the ledger in 624. Using the received investor addresses, the creation/settlement system 104 can determine the last prior investor addresses before the freeze event was executed (626). The most current token holders just prior to the freeze event (e.g., the settlement) are those that should receive pay out of their tokens. Thus, an entity that tried to purchase the token at a time of the settlement event or execution of the freeze event may not be the most current token holder. That entity would not receive pay out of the token. The system 104 can identify the last prior investor addresses by reviewing the transaction history for each of the associated token addresses.

Token returns can be paid out in a stable currency based on the last prior investor addresses in 628. The law firm 100 can hold settlement funds in escrow until the last prior investor addresses are identified and the creation/settlement system 104 is ready to pay out token returns. The settlement funds can then be used by the system 104 to pay out token returns. As described throughout this disclosure, the stable currency for payout can be outlined in the litigation product contract. The stable currency for payout can also be the currency of the settlement funds that are held in escrow by the law firm 100. The stable currency can also be different for each current token holder. For example, each current token holder can receive their token returns in whatever stable currency they used to purchase the tokens.

The process 600 depicted in FIGS. 6A-B can be repeated/performed for every pending litigation having a litigation product contract and litigation product token in circulation. In some implementations, if settlement falls through (e.g., the litigation resumes), then the frozen tokens can become unfrozen. The nodes in the network can be configured to undo or unlock the freeze event on all token addresses associated with that litigation. The associated token can then be put back in circulation in the marketplace until another settlement event occurs or the litigation ends with a favorable or unfavorable resolution. Moreover, holders of the associated tokens can be notified that the tokens are no longer frozen and that they can be moved or traded once again in the marketplace.

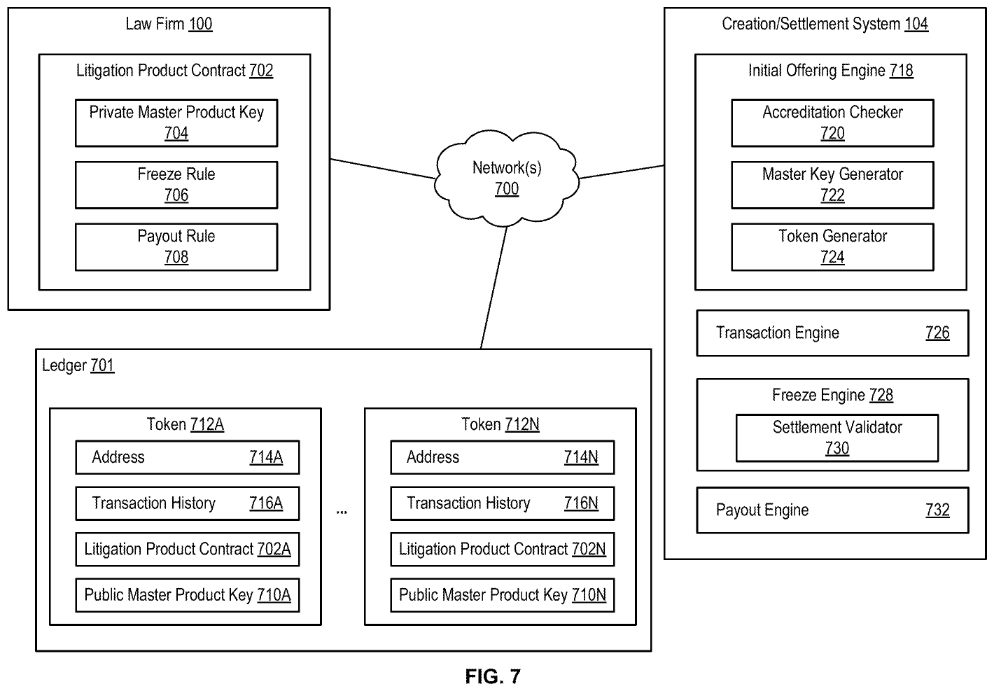

FIG. 7 is a system diagram of components of the example computing environment. The law firm 100 can be in communication with the creation/settlement system 104 and a ledger 701 via network(s) 700. The law firm 100, creation/settlement system 104, and the ledger 701 can further be in communication with the exchange computing system 106, as described throughout this disclosure. The exchange computing system 106 can be an existing exchange or marketplace platform or environment that provides for trading different types of digital assets across different blockchains or ledgers.

The law firm 100 can have a litigation product contract 702. As described throughout this disclosure, the creation/settlement system 104 can create the litigation product contract 702 when the law firm 100 notifies the system 104 of an occurrence of a litigation event. For example, the contract 702 can be generated once the law firm 100 enters into a lawsuit and is seeking litigation funding for that lawsuit.

The contract 702 can be added to the ledger 701. A copy of the contract 702 can be held or maintained by the law firm 100. The litigation product contract 702 can include a private master product key 704, a freeze rule 706, and a payout rule 708. Thus, the private master product key 704 can be held by the law firm 100 while a public master product key can be added to the ledger 701. The private master product key 704 can be used to generate a signature for the law firm 100 whenever the law firm 100 sends a request to the creation/settlement system 104 (e.g., a request to execute a freeze event upon the happening of a settlement event).

The freeze rule 706 can indicate what phases, stages, milestones, or events in the litigation can result in the freeze event being executed. For example, the freeze rule 706 can require a settlement event with a predetermined minimum settlement amount to occur before the law firm 100 can invoke the freeze event to freeze all tokens associated with the litigation product contract 702.

The payout rule 708 can dictate how token returns are to be paid out, when payout occurs, and/or what stable currency or coin to pay out the token returns. One or more other terms and conditions can be outlined by the payout rule 708.

As described throughout this disclosure, the contract 702 can include one or more additional or alternative terms, conditions, and rules. The contract 702 can dictate the terms, conditions, and rules for all associated tokens. The terms, conditions, and rules of the contract 702 can be determined by the law firm 100 and/or the creation/settlement system 104. For example, boilerplate terms, conditions, and/or rules can be inserted into one or more different litigation product contracts.

The creation/settlement system 104 can include an initial offering engine 718, a transaction engine 726, a freeze engine 728, and a payout engine 732. One or more different engines can be included in or part of the creation/settlement system 104. The initial offering engine 718 can include an accreditation checker 720, a master key generator 722, and a token generator 724. The initial offering engine 718 can be configured to generate litigation product contracts and associated litigation product tokens. For example, the public and private master product key pair for each litigation product contract 702 can be generated by the master key generator 722. Known techniques can be used to generate the key pairs. When tokens are initially offered to investors, the accreditation checker 720 can verify whether such an initial investor is accredited or non-accredited. The accreditation checker 720 can use known techniques to identify a status of the initial investor, as described throughout this disclosure. Based on the accreditation status determined by the accreditation checker 720, the token generator 724 can generate locked or unlocked tokens for the initial investor. The token generator 724 can generate or create tokens that are initially locked for a one year period and assign such tokens to an initial investor who is non-accredited. The generator 724 can create tokens that are unlocked and assign such tokens to an initial investor who is accredited. The litigation product contract, public master product key, and tokens generated by the initial offering engine 718 can be added to the ledger 301.

The transaction engine 726 can be configured to verify and validate a sell request and execute that sell request. As described throughout this disclosure, the transaction engine 726 can be in communication with the exchange computing system 106 in order to complete token transactions. The transaction engine 726 can be configured to receive a sell request from an investor (e.g., current token holder) along with the investor's signature. Using the signature, the transaction engine 726 can verify the investor against information that is associated with the public master product key on the ledger. The transaction engine 726 can also be configured to determine whether a token in the sell request has an initial locked status. If the transaction engine 726 determines that the investor is the current token holder and that the token is unlocked, the engine 726 can accept the sell request. The exchange computing system 106 can then execute the sell request by transferring the token from the seller's wallet to the purchaser's wallet and assigning the token address to the purchaser address.

The freeze engine 728 can be configured to invoke the freeze event for a certain litigation. The freeze engine 728 can be in communication with nodes of the exchange computing system 106. As described throughout the disclosure, the nodes of the blockchain can execute the freeze event. Before the freeze event can be executed, it must be determined whether execution of the event is proper.

Thus, the freeze engine 728 can be configured to receive a settlement event and request to invoke the freeze event from the law firm 100. A settlement validator 730 of the freeze engine 728 can be configured to determine whether the settlement event is in fact a valid event for invoking the freeze event. For example, the settlement validator 730 can check the settlement event received from the law firm 100 against public court filings and/or the litigation product contract. If the received settlement event is recorded in the public court filings, for example, then the validator 730 can determine that invoking the freeze event is proper. The litigation product contract can also outline what types of events or stages in the litigation constitute settlement events. For example, the contract can indicate that a settlement event is one in which parties to the litigation enter negotiations with a minimum settlement amount. If the received settlement event does not match one of the outlined settlement events in the contract, then the validator 730 can determine that the request to invoke the freeze event is invalid and therefore denied. Thus, the tokens associated with that litigation product contract can remain freely tradeable in the marketplace.

The freeze engine 728 can also be configured to validate the settlement event based on verifying the law firm 100's request. In other words, the freeze engine 728 can receive a signature from the law firm 100. The signature can be generated using the private master product key 704. The freeze engine 728 can verify the signature against the public master product key that is stored on the ledger 701. If the signature matches the public master product key, then the freeze engine 728 can determine that the request to invoke the freeze event is valid.

As mentioned, if the settlement event is validated, the freeze engine 728 can send notification to the nodes of the exchange computing system 106. The notification can instruct the nodes to execute the freeze event, thereby freezing all of the associated tokens in token holder wallets and the marketplace.

The payout engine 732 can be configured to pay out token returns in a stable currency. Once the settlement event occurs and all associated tokens are frozen, the payout engine 732 can verify that all the associated tokens are in fact frozen. The payout engine 732 can then receive investor addresses (e.g., from the ledger 701) for token holders immediately prior to execution of the freeze event. The payout engine 732 can pay the token returns to these received investor addresses. In some implementations, the payout engine 732 can determine what stable currency to pay out the token returns. The payout engine 732 can also access the litigation product contract from the ledger 701 to apply the appropriate payout rules 708 (e.g., the rules 708 can dictate what stable currency to pay out token returns). Therefore, the payout engine 732 can receive a settlement amount held in escrow from the law firm 100 and use it to pay out the token returns to the received investor addresses. In some implementations, the payout engine 732 can also be configured to dissolve the litigation product token once all the investor addresses are paid their token returns and/or any overage of the settlement amount is paid to the law firm 100.

The ledger 701 can be any distributed ledger or blockchain, as described throughout this disclosure. The ledger 701 can be the ledgers 300, 310, and/or 320 as depicted and described in reference to FIGS. 3A-C. As depicted in FIG. 7, the ledger 701 can include information associated with each token 712A-N. Each of the tokens 712A-N can be generated for a different litigation and therefore a different litigation product contract.

The token 712A can include a unique token address 714A, transaction history 716A, litigation product contract 702A, and public master product key 710A. The token address 714A can be assigned to an investor's address once that investor becomes a current holder of the token 712A. The token address 714A can be used to identify the token 712A, whether the token 712A is in the investor's wallet, part of a sell request, circulating in the marketplace, or otherwise being traded or transferred from one wallet to another.

The transaction history 716A can indicate any exchange of the token 712A during a lifespan of the associated litigation. As described throughout this disclosure, the token history 716A can indicate when the token 712A was initially offered/generated, when it was transferred from one investor to another, when and if the token 712A was/is in a lockup period, when and if the lockup period was/is removed, when a freeze event is executed, and when a payout of the token 712A's returns occurs. Information in the transaction history 716A can include relevant investor addresses (e.g., when an exchange occurs between two investors, the transaction history 716A can indicate an address of the selling investor and an address of the purchasing investor) and timestamps.

The litigation product contract 702A can be part of the token 712A. In other implementations, the contract 702A can be referenced by a key, such as the public master product key 710A, wherein the key is part of the token 712A. The contract 702A can outline terms, conditions, and rules associated with the token 712A (e.g., the freeze rule 706, the payout rule 708), as described throughout this disclosure. As depicted in FIG. 7, the contract 702A can follow every instance or generation of the token 712A. Therefore, the contract 702A can be easily and quickly accessed whenever movement or a request to move the token 712A is made. Finally, as depicted in FIG. 7, the token 712A can include the public master product key 710A. The key 710A can be used for a variety of purposes (e.g., verifying and validating sell requests, validating investor addresses, freezing the token 712A upon the happening of a settlement event, etc.) as described throughout this disclosure. Moreover, like the litigation product contract 702A, the public master product key 710A can follow every instance or generation of the token 712A.

Every generated litigation product token can include information as described in reference to the token 712A. For example, the ledger 701 can also include an address 714N, transaction history 716N, a litigation product contract 702N, and a public master product key 710N for the token 712N.

Although the disclosed technology is described with regard to litigation funding, the technology can be used for any smart contract where a recovery will be paid to token holders based on the outcome of one or more events that would freeze the exchange of tokens. For example, the disclosed technology can be used to raise financing for business ventures where a recovery is paid to token holders upon the business venture achieving one or more metrics, milestones, or other events, which could trigger a freezing event. Any of a variety of other examples are also possible.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for providing a litigation funding platform and exchange, the system comprising:
a user device configured to generate a litigation event;
an initial litigation product offering computer system configured to:
receive, from the user device, the litigation event;
generate, based on the litigation event, (i) a litigation product contract, (ii) a master product key pair for the litigation event that includes a public key and a private key, and (iii) a freeze rule;
provide an initial offering of litigation product tokens, wherein the initial offering incorporates, at least, the litigation product contract;
receive requests to purchase the litigation product tokens as part of an initial public offering;
generate a plurality of litigation product tokens that each include the litigation product contract, the public key, and the freeze rule; and
generate a token ledger that includes initial entries for the plurality of litigation product tokens; and
a digital exchange system configured to:
determine whether to permit a digital trade of a particular litigation product token based, at least in part, on whether a freeze event is present in the token ledger for the particular litigation product token and whether a signature included as part of the freeze event is validated by the public key.

2. The system of claim 1, wherein the initial litigation product offering computer system is further configured to:
determine whether entities associated with each of the requests is an accredited entity or non-accredited entity based on signatures associated with the entities,
wherein each of the plurality of litigation product tokens is generated as either being locked or unlocked based on whether a corresponding entity purchasing the litigation product token is an accredited entity or a non-accredited entity;
wherein the digital exchange system is configured to:
permit trades for unlocked tokens using the token ledger; and
block trades for locked tokens that are within a lockup period for the litigation product tokens, wherein the lockup period comprises a predefined period of time that starts to run at a time when the litigation product tokens were initially generated.

3. The system of claim 2, wherein the lockup period is one year long from a timestamp for a locked instance of the litigation product token.

4. The system of claim 1, wherein the initial litigation product offering computer system is further configured to:
receive, from the user device, (i) a settlement event and (ii) a request to invoke a freeze event;
generate, based on the private key from the user device, a signature for the settlement event; and
send, to the digital exchange system for all of the plurality of litigation product tokens, (i) the request to invoke the freeze event, and (ii) the signature for the settlement event; and
wherein, for each of the plurality of litigation product tokens, the digital exchange system is further configured to:
receive, from the initial litigation product offering computer system, (i) the request to invoke the freeze event, and (ii) the signature for the settlement event;
retrieve, from the token ledger, the public key;
validate, using the freeze rule, the signature for the settlement event using the public key; and
add the freeze event to the token ledger for the litigation product token.

5. The system of claim 4, wherein the initial litigation product offering computer system is further configured to:
verify that all instances of the litigation product token are frozen in the digital exchange;
retrieve, from the token ledger, addresses for entities that are assigned the addresses for all the instances of the litigation product token;
determine, based on the retrieved addresses for the entities, last prior addresses for the entities that were assigned to the addresses for all the instances of the litigation product token before execution of the freeze event; and
pay out each of the instances of the litigation product token to the last prior addresses for the entities.

6. The system of claim 5, wherein the initial litigation product offering computer system is further configured to:
determine, for each of the last prior addresses for the entities, whether the last prior address is associated with an authenticated entity; and
in response to determining that a particular last prior address is not associated with an authenticated entity, sending to the particular last prior address, a notification that an authentication process is to be performed by the entity before instances of the litigation product token are to be paid out to the particular last prior address for the entity.

7. The system of claim 5, wherein the initial litigation product offering computer system is further configured to pay out each of the instances of the litigation product token in a stable currency.

8. The system of claim 5, wherein the initial litigation product offering computer system is further configured to dissolve the litigation product token after paying out each of the instances of the litigation product token.

9. The system of claim 8, wherein dissolving the litigation product token comprises removing the litigation product token from circulation in the digital exchange and removing a value assigned to the litigation product token.

10. The system of claim 1, wherein the litigation event is a start of a lawsuit or legal claim.

11. The system of claim 1, wherein the litigation product contract is a smart contract.

12. The system of claim 1, wherein the freeze rule is executed by the digital exchange system based on determining that a valid settlement event has occurred.

13. The system of claim 1, wherein the litigation product contract includes a payout rule that designates a stable currency to pay out litigation product token returns.

14. The system of claim 4, wherein the private key is stored at the user device.

15. The system of claim 4, wherein the settlement event is a phase in the litigation event when resolution is being negotiated by parties to the litigation event.

16. The system of claim 2, wherein a locked instance of the litigation product token is prevented from being traded in the digital exchange for a period of time that begins when the locked instance of the litigation product token is generated.

17. The system of claim 2, wherein the digital exchange system is further configured to send, to an address of the entity, a notification that a sell request was denied, wherein the notification indicates that the instance of the litigation product token is a locked instance of the litigation product token.

18. The system of claim 2, wherein the digital exchange system is further configured to send, to an address of a second entity, a copy of the litigation product contract associated with the instance of the litigation product token, wherein the copy of the litigation product contract includes at least a payout rule.

19. The system of claim 4, wherein the digital exchange system is further configured to send, to addresses for entities that are assigned the addresses for all the instances of the litigation product token, a notification indicating at least one of (i) occurrence of the settlement event and (ii) execution of the freeze event.

20. The system of claim 4, wherein execution of the freeze event comprises preventing all the instances of the litigation product token from being traded in the digital exchange from a time at which (i) the settlement event occurs or (ii) the freeze event is executed.

21. The system of claim 4, wherein execution of the freeze event comprises stopping sell requests for one or more instances of the litigation product token, wherein the sell requests occur at a time at which (i) the settlement event occurs or (ii) the freeze event is executed.

22. A method for providing a litigation funding platform and exchange, the method comprising:
receiving a litigation event;
generating, based on the litigation event, (i) a litigation product contract, (ii) a master product key for the litigation event that includes a public key and a private key, and (iii) a freeze rule;
providing an initial offering of litigation product tokens, wherein the initial offering incorporates, at least, the litigation product contract;
receiving requests to purchase the litigation product tokens as part of an initial public offering;
generating a plurality of litigation product tokens that each include the litigation product contract, the public key, and the freeze rule;
generating a token ledger that includes initial entries for the plurality of litigation product tokens; and
determining whether to permit a digital trade of a particular litigation product token based, at least in part, on whether a freeze event is present in the token ledger for the particular litigation product token and whether a signature included as part of the freeze event is validated by the public key.

23. The method of claim 22, further comprising:
determining whether entities associated with each of the requests is an accredited entity or non-accredited entity based on signatures associated with the entities, wherein each of the plurality of litigation product tokens is generated as either being locked or unlocked based on whether a corresponding entity purchasing the litigation product token is an accredited entity or a non-accredited entity;
permitting trades for unlocked tokens using the token ledger; and
blocking trades for locked tokens that are within a lockup period for the litigation product tokens, wherein the lockup period comprises a predefined period of time that starts to run at a time when the litigation product tokens were initially generated.

24. The method of claim 23, wherein the lockup period is one year long.

25. The method of claim 23, further comprising generating a notification that a trade was blocked, wherein the notification indicates that the trade was for locked tokens that are within the lockup period for the litigation product tokens.

26. A method for freezing a litigation product token in a litigation funding platform and exchange, the method comprising:
receiving (i) a settlement event, and (ii) a request to invoke a freeze event;
generating a signature for the settlement event;
retrieving, from a ledger, a public master product key that is associated with the litigation product token;
validating, using a freeze rule, the signature for the settlement event using the public master product key; and
adding the freeze event to a token ledger for the litigation product token.

27. The method of claim 26, further comprising:
verifying that all the instances of the litigation product token are frozen in the litigation funding platform and exchange;
retrieving, from the token ledger, addresses for entities that are assigned the addresses for all the instances of the litigation product token;
determining, based on the retrieved addresses for the entities, last prior addresses for the entities that were assigned to the addresses for all the instances of the litigation product token before adding the freeze event to the token ledger; and
paying out each of the instances of the litigation product token to the last prior addresses for the entities.

28. The method of claim 27, further comprising dissolving the litigation product token, wherein dissolving the litigation product token comprises:
removing the litigation product token from circulation in the litigation funding platform and exchange; and
removing a value assigned to the litigation product token.

29. The method of claim 26, wherein adding the freeze event to the token ledger comprises preventing all the instances of the litigation product token from being traded in the litigation funding platform and exchange from a time at which (i) the settlement event occurs or (ii) the freeze event is added to the token ledger.

30. The method of claim 26, wherein adding the freeze event to the token ledger comprises stopping sell requests for one or more instances of the litigation product token, wherein the sell requests occur at a time at which (i) the settlement event occurs or (ii) the freeze event is executed.
